(19) United States
(12) Patent Application Publication
(10) Pub. No.: US 2014/0285339 A1
(43) Pub. Date: Sep. 25, 2014

(54) COMPUTER-IMPLEMENTED ANIMAL SHELTER MANAGEMENT SYSTEM

(71) Applicant: SQUISHYCUTE.COM LLC, Boca Raton, FL (US)

(72) Inventor: MARC P. THALHEIM, BOCA RATON, FL (US)

(73) Assignee: SQUISHYCUTE.COM LLC, Boca Raton, FL (US)

(21) Appl. No.: 14/267,654

(22) Filed: May 1, 2014

Related U.S. Application Data
(63) Continuation-in-part of application No. 13/749,357, filed on Jan. 24, 2013.
(60) Provisional application No. 61/590,962, filed on Jan. 26, 2012.

(51) Int. Cl. G06Q 30/06; H04W 4/02; G08B 21/18; G06Q 10/10; G06Q 10/06

(52) U.S. Cl. CPC G06Q 30/0609; G06Q 10/107; G06Q 10/06311; G06Q 10/063114; G08B 21/18; H04W 4/021
USPC 340/539.13; 705/26.35; 705/7.13; 705/7.15; 705/2; 705/3; 705/317

(57) ABSTRACT

The system provides templates which assist shelters in creating customized pet adoption applications and automatically scans responses to reject or flag applications with certain answers. The system tracks the application process, automatically assigns staff to review applications, maintains applicant denied/accepted lists, facilitates transfer of adoption documents, provides updated application status information, sends accepted applicants medical and other service related messages, provides animal transfer information and preforms automatic background checks. The system calculates estimated pet care costs and provides for instant pet registration at external registries. A software application for smartphones/tablets allows scanning of implanted GPS microchips, tracking of animal locations, proximity detection and identification of emergency rescue services proximate the location of the animal.

### CROSS-REFERENCE TO RELATED APPLICATIONS

This application is a continuation-in-part of and claims priority on application Ser. No. 13/749,357, filed Jan. 24, 2013, which application claims priority on Provisional Patent Application Ser. No. 61/590,962, filed Jan. 26, 2012.

### STATEMENT REGARDING FEDERALLY SPONSORED RESEARCH OR DEVELOPMENT

Not Applicable

### REFERENCE TO A “SEQUENCE LISTING”, A TABLE, OR A COMPUTER PROGRAM LISTING APPENDIX SUBMITTED ON COMPACT DISC

Not Applicable

### BACKGROUND OF THE INVENTION

1. Field of the Invention

The present invention relates to animal shelter management, including: animal adoption using customized application having tracking and documentation capabilities, automatic application rejection and flagging, automated designation for application review, storage of denied/accepted lists, input of paper applications, automatic updating of pet adoption information; animal medical history recordation and medical reminder notification; inter-kennel animal transfer; staff, volunteer and foster tracking; expense tracking; animal lost and found; and smartphone/tablet applications for reading implanted microchips, and more particularly, to an internet or wireless device-based, computer-implemented animal shelter management system and method capable of preforming those functions.

2. Description of Prior Art Including Information Disclosed Under 37 CFR 1.97 and 1.98

Although an individual animal welfare organization (“AWO”) may provide animal adoption services and to some extent record the medical histories of the animals, there does not exist an internet-based, computer-implemented animal shelter management system for connecting animal welfare organizations, such as animal shelters, and people looking to adopt animals, both before and after adoption.

Presently, people desiring to adopt animals must inquire at individual shelters as to what animals are available and once an adoptable animal is located at a particular shelter, travel to the shelter to see the animal, and if available learn about the medical history of the animal and the like. There is no centralized clearing system which assists people in determining the breed or breeds they wish to adopt or provides for searching for adoptable animals of a particular breed. The necessary software and hardware does not exist to broadcast live feeds of adoptable animals of a chosen breed on a website and automatically send out the adoptable animal list to similar websites, thus increasing online exposure.

No system exists in which a person looking to adopt an animal can conduct an attribute-based search and observe adoptable animals in live feeds, eliminating the necessity of having to waste time, energy, and money traveling to various shelters.

Further, presently there is no such system by which animal shelters can efficiently manage operations and personnel. Such operations include monitoring tracking financial resources, tracking the activities of staff, volunteers and temporary caregivers (fosters).

There is no system which electronically maintains the medical histories of the animals in the care of the shelter. There is no system which allows people looking to adopt an animal to access the medical histories of animals available for adoption online. There is no system by which permits veterinarians to record and update the medical histories of the animals in their care.

There is no system capable of facilitating inter-kennel animal transfer. Further there is no system capable of functioning as an online animal lost and found.

Currently, no system includes software designed to help people who have adopted care for their new animal through by means of an online post-adoption information tracking center.

There is no system which has software for optimizing the application process, including data tracking and documenting capabilities which allow an AWO to create customized adoption, foster and volunteer applications using automated templates recommended by the system and which can automatically reject and/or flag applications based upon predetermined answer selections. There is no system which allows staff to access and review adoption applications, to set up automated denied/accepted lists, to input paper applications into the system, to automatically update pet adoption posts, to automatically transfer adoption documents, or to communicate with accepted applicants concerning reminders, check-ins and updates. There is no system which is capable of providing automated application status updates, or to provide transportation or other pet transfer information. There is no system which allows for automated background checks of persons applying for pet adoption.

There is no system which provides for automated medical reminders and expense tracking. There is no system which can automatically estimate the cost of maintaining a dog or cat at an AWO. There is no system which is capable of instant pet service registration.

Further, these is no system which includes a smartphone/table application for scanning implanted pet microchips, which provides microchips which are tractable by a smartphone/table application or on a website, that can provide instant lost notifications to pet owners, provide GPS/Satellite/Location tracking information or provide emergency information proximate the location of a pet.

The internet or wireless device-based, computer-implement animal management system of the present invention has been developed to provide all of the above capabilities and features.

### BRIEF SUMMARY OF THE INVENTION

The present invention relates to an internet or wireless device-based computer-implemented system which includes a website or wireless device application which enables users to create a search in which the user can select attributes and a list of breeds (dog or cat) is returned that matches the inputted criteria. The unique searching ability of the system allows a user to determine the breed on the animal they most prefer adopt, if they enter they system without that knowledge.

The user initiated search/match process employed by the system may take place through a manually entered database linking a dog or cat breed with their specific set of attributes. When a user enters a search query (by selecting various attributes) the system software cross-references the database and returns a list of matching breeds. A unique algorithm is utilized to calculate a weighted score for each breed based on how the breed attributes match the user inputted attributes. The breeds with the highest scores (the most matching attributes) are returned to the user along with a list how many animals of those breeds are up for adoption in nearby participating shelters. A breed description is also provided.

In addition, the present invention directly links a live video feed to the adoption process. Other sites let a shelter post videos, but they don't allow them to record directly through the website or wireless device application. Using the software on the system, users can even request that shelter personnel play with an adoptable animal in front of the live feed to allow a person to better assess the personality of an animal without having to actually visit the shelter. The shelter will be able to charge a small fee for this service. If the user likes the animal, he/she can adopt it through the system, which supplies the user with an adoption application and processes the paper work.

The system has the ability to perform an attribute based search as part of the pet adoption process. A user wishing to adopt an animal enters the attributes of the animal the user is looking for into the system through the system website. The system searches the system database to locate animals available for adoption in participating shelters and returns to the user a list of available animals that most closes match the entered attributes, along with information about each animal, which may include an image of the animal or a live video feed of the animal.

The system includes a database containing the attributes of various animal breeds, The attributes have each been assigned a weighted value by the system administrator. The system has means by which a user may enter into the system the attributes of an animal which the user desires to adopt. The system includes means for automatically matching the attributes of the animal the user desires to adopt, with the attributes contained in the database, to identify the breeds that include animals having attributes closest to the attributes entered by the user. The automatic matching means employs an algorithm for selecting breeds closest to the attributes entered by the user by matching the attributes of the breeds contained in the database with the attributes entered by the user, and assigning each breed a score based upon the weighted value assigned to each matching attribute. Means are provided for displaying information through the system relating to the breeds having the highest scores.

The unique post adoption software of the system provides a single online or wireless device-accessible location for people to keep all records relating to their adopted pet. The system software automatically creates an account for anyone who adopts and e-mails them all records associated with the pet. This is done by pulling the information from various databases within the system. These databases are set up so that user can instantly populate them with important information by creating a portal where shelters and veterinarians can log in and update medical information for each pet on the system website or through the wireless device application. Anyone with proper access can see medical records, micro-chip information, pet insurance, supplies vet information, and everything else associated with taking care of their pet in one location.

The software of the system allows the sharing of revenues collected from advertising with participating shelters. This can be accomplished using existing websites such as balancedpayments.com. Any user can pay for an ad slot and instantly upload their ad to the system website or wireless device for approval. This automates the revenue sharing process and increases efficiency throughout the entire process.

The system of the present invention includes an innovative pet transfer network which eliminates the need for representatives of shelters seeking to receive animals to visit shelters that may have animals to transfer to locate an animal to transfer, fill out all transfer documents offline, and complete the entire process manually. The system of the present invention automates the transfer process by providing shelters with a transfer form, the ability to approve or deny a requested transfer electronically, and allows shelters to search through a system database containing information about of all transferable animals.

The system of the present invention allows shelters to directly communicate with their staff, volunteers, and fosters through an online medium. For example, the system allows fosters to run live feeds of their pets on the website. It allows volunteers to update important information remotely and create/schedule events. It permits shelters to accept/reject applications electronically and send messages directly to anyone involved with them. It allows shelters to talk to fosters and volunteers via internal chat rooms and messaging system. Moreover, shelters can assign staff members to certain volunteers and fosters through the system to help better manage them.

The system of the present invention includes databases including information on lost animals and found animals and includes software that automatically alerts the user if a potential match has been found. This is done by allowing users to enter in attributes of both lost and found pets.

For example, a lost adult male pet in the zip code 10016 is entered into the system though the website. This pet's information is stored in a “lost” database. If someone finds an adult male within the same zip code and enters it as a found pet, in a “found’ database”, odds are it will be the same pet that was entered into the “lost” database. By comparing the “lost” database to the “found” database, the system will be able to find this potential match by comparing attributes, and automatically alerts both parties of the potential match.

This eliminates the necessity for the user has to look for a match manually by searching through a database that only contains lost animals, which can be incredibly time-consuming because the wrong attributes may have been entered, or possible matches may be overlooked. The software of the system of the present invention solves this issue by alerting the user of “similar” matches in the “lost” database and “found’ database, so even if the users entered in slightly different attributes for the same pet, a match can still be found.

For users wishing to adopt a particular breed which is not currently available, the system of the present invention allows users to automatically be alerted when the specified breed(s) becomes available within a given geographical radius. That is done by combining a request database (which lists breeds that different users request) with the system pet database. If a zip code and breed match are found, the system will notify that user via email automatically and provide the user with an adoption application immediately.

The system software also assists users to figure out an ideal pet for them based on the responses to a set of questions provided to the user through the website or wireless device application. This is done by creating a database that matches answers to each question with each breed.

The system utilizes fully customizable application software which has complete tracking/documentation capabilities and auto-reject/flagging of applications. It allows AWO's to create their own adoption, foster and volunteer applications, and to flag and/or automatically reject applications with unsuitable responses. The system tracks return rates and assists AWO's to increase adoption rates and reduce returns. It also allows tracking of all documents and notes associated with the adoption process which can be transferred to adopters, fosters and volunteers after approval of the adoption, as well as tracking the application history and pet history when updated.

The system software allows any AWO to set up automatic reminders for medical procedures for each pet in their account and to track all medical expenses for each pet.

The system software can automatically calculate an estimate of the cost of maintaining a dog or cat at the AWO.

The system provides for instant pet service registration by sending all of the pet's registration information to the adopter's account on the system website. Through the website, messages may be sent to and received from the AWO and to use the stored information to automatically register the pet with outside agencies, such as for state licensing.

The system software includes downloadable smartphone or tablet applications (“apps”) which allow the user to scan identification microchips implanted in pets that are lost. It also includes a special pet microchip which can automatically notify the pet's owner as to the current location of their pet using GPS/Satellite/Location tracking and can provide the owner with the contact information of emergency rescue service providers in the vicinity of a lost pet and a rating as to how well such providers have functioned historically in similar situations.

More specifically, the present invention relates to an internet or wireless device-based, computer-implemented animal management system which includes a network of participating animal shelters. The system has a database which contains information about the attributes of various animal breeds. The database also includes information about the attributes of the animals in participating shelters available for adoption.

The system has means by which a user may enter into the system, using the system website or wireless device application, the attributes of an animal which the user desires to adopt. The system includes means for automatically matching the attributes of the animal the user desires to adopt, with the attributes of animals in participating shelters available for adoption, to identify animals in participating shelters available for adoption which have the attributes of the animal the user desires to adopt. Once adoptable animals are identified by the system, means are provided for displaying information on the system website or wireless device relating to the identified animals identified. Means are provided by which the user may notify the system through the system website as to which of the identified animals the user has selected to adopt. Once the selection is made, the system has means for forwarding to the user, through the system website or wireless device application, an application for the adoption of the selected animal.

The system database includes the attributes of each of a plurality of animal breeds. Means are provided for displaying information as to each breed having the attributes of the animal the user desires to adopt. Means are also provided by which the user may notify the system of the breed of animal the user selects to adopt.

Means for automatically matching the selected breed of the animal the user desires to adopt, with the breeds of animals in participating shelters available for adoption, are provided to identify animals available for adoption in participating shelters of the selected breed.

Means are provided by which the user may notify the system of the breed of animal the user desires to adopt. The system includes means for automatically identifying animals in participating shelters available for adoption of the breed the user desires to adopt.

The system also includes means by which a user may enter into the system, through the system website or wireless device application, geographic limitations as to the location of animal shelters to be searched for animals available for adoption and means for limiting the automatic matching means to search animal shelters in accordance with the entered geographic limitation.

The means for displaying information on the system website or wireless device relating to the animals identified by the system includes means for displaying an image of the identified animal. The displayed image may include a video showing the identified animal. Preferably, the video is a live feed showing the identified animal.

The means for displaying information on the system website or wireless device also includes means for displaying a description of an identified animal.

The system further includes a database for storing the medical records of the animals in participating shelters available for adoption. Means are provided for allowing a user to access the medical records database, through the system website or wireless device, to review the medical records of an identified animal.

The system further includes means for automatically creating a user accessible webpage or wireless device application including information relating to the animals identified by the system. The webpage or wireless device application includes an image of the identified animal.

The system further includes means for automatically creating a user accessible webpage or wireless device application including an image of an animal of the each breed having the attributes of the animal the user desires to adopt.

The system further includes means for the system administrator to enter information into the database.

The system further includes means for the system administrator to enter the medical records of animals available for adoption into the database.

The system permits the system administrator to create an adoption application and further includes means in the system for storing the adoption application. Preferably, the adoption application is suitable for use by all participating shelters.

The system provides means by which the user can submit the completed adoption application to the system, through the system website or wireless device application, after the user completes the adoption application. Means are provided for automatically processing the adoption of the selected animal by the user upon approval of the submitted completed adoption application.

The adoption processing means includes means for associating the adopted animal with the user that adopted the animal in the system. The associating means includes means for associating the adopted animal with the account of the user in the system, if the user has an account. If the user does not have an account in the system, the associating means includes means for creating an account in the system for the user, and means for associating the adopted animal with the account of the user.

The system includes means by which a veterinarian can enter the medical records database, through the system website or wireless device application, and access the medical records of an animal in the system database. The system includes means by which a veterinarian can update the medical records of an animal in the system database, through the system website or wireless device application. The system includes means by which a veterinarian can add an animal into the system and update the medical records of that animal in the system database through the system website or wireless device application.

The system includes means for submitting advertisements for display on the system website or wireless device application. The system further includes means for collecting revenue for displaying submitted advertisements through the system and means for sharing such revenues with participating animal shelters. The submitted advertisements are reviewed, and the system further includes means for immediately displaying submitted advertisements on the system website or wireless device application, upon approval. The system also has means for associating a submitted advertisement with an animal in the system database, if the advertiser wishes to sponsor a particular animal.

The system further includes means for accepting donations through the system website or wireless device application for distribution to participating animal shelters.

In accordance with another aspect of the present invention, an internet or wireless device-based, computer-implemented animal management system is provided including a plurality of participating animal shelters capable of housing animals for adoption. The system includes a database containing information as to participating animal shelters having animals available for adoption which animals can be transferred to other shelters for adoption. Means are provided for automatically searching the database to identify participating shelters with transferrable animals available for adoption. The system includes means for automatically creating the documents necessary to transfer of an animal from an identified shelter to a shelter seeking animals for adoption; means for forwarding the documents through the system to the identified shelter with the transferrable animals, and means for scheduling a time for a representative of the animal shelter seeking animals to adopt to examine and pick-up the animal to be transferred.

The means for automatically searching the database includes means for limiting the search based on specific searching criteria. The specific searching criteria are entered into the system through the system website by a representative of the animal shelter seeking transfer. The specific searching criteria may include geographic location and/or particular attributes of the animal to be transferred.

The system further includes means for entering into the database the attributes of an animal in a participating shelter which is available for transfer and means for limiting the search of the database by selecting for the attributes entered in the database.

In accordance with another aspect of the present invention, an internet or wireless device-based, computer-implemented animal management system is provided including a plurality of participating animal shelters housing animals for adoption. The system includes means for automatically tracking the activities of staff members associated with the participating shelters. The tracking means includes means for identifying the job duties of a staff member; means for recording when a staff member makes a purchase on behalf of the associated shelter; means for storing salary information for the staff member; and means for assigning staff members for certain events.

In accordance with another aspect of the present invention, an internet or wireless device-based, computer-implemented animal management system is provided including a plurality of participating animal shelters housing animals for adoption. The system includes means for automatically facilitating the activities of volunteers and foster caregivers associated with the participating shelters. The facilitating means includes means for accepting applications to be a volunteer or foster caregiver through the system and means for allowing volunteers and foster caregivers to sign up through the system to participate in events run by the associated animal shelter. It includes means for an animal shelter to track the events and times through the system that volunteers and foster caregivers associated with the shelter volunteer for, as well as means for an animal shelter to track through the system how much volunteers and foster caregivers associated with the shelter have donated or contributed to the shelter over time.

In accordance with another aspect of the present invention, an internet or wireless device-based, computer-implemented animal management system is provided including a plurality of participating animal shelters housing animals for adoption. The system includes means for automatically facilitating the activities of foster caregivers associated with the participating shelters. The facilitating means includes means for tracking the foster caregivers associated with a participating shelter through the system. The system also provides means through which foster caregivers can post images of the animals in their care on the system and means for a participating shelter to identify through the system the foster caregiver in charge of each animal for which the shelter is responsible.

Preferably, the images of the animals posted on the system website include live video feeds.

In accordance with another aspect of the present invention, an internet or wireless device-based, computer-implemented animal management system is provided including a network of participating animal shelters. The system includes a database containing the information about the breed of animals currently in participating shelters and information about the breed of animals entering participating shelters. Means are provided by which a user may enter into the system, through the system website or wireless device application, a breed of animal which the user desires to adopt. The system has automatic means for matching the breed of the animal the user desires to adopt, with the breeds of animals entering the participating shelters, to identify animals entering participating shelters of the breed the user desires to adopt. The system also has means for notifying the user, through the system, that an animal of the breed the user desires to adopt has entered a participating shelter.

The system also includes means for actuating the automatic matching means only after searching the database to ascertain that an animal of the breed that the user desires to adopt is not currently in a participating shelter.

In accordance with another aspect of the present invention, an internet or wireless device-based, computer-implemented animal management system is provided including a network of participating animal shelters. The system includes a database containing information about the breeds of animals currently in participating shelters, information about the breeds of animals entering participating shelters, and information about certain attributes of participating shelters. The system includes means by which a user may enter into the system, through the system website or wireless device application, a breed of animal which the user desires to adopt and certain attributes of the participating shelter from which the user desires to adopt. The system has automatic means for matching the breed of the animal the user desires to adopt, with the breeds of animals entering participating shelters having the attributes of the participating shelter from which the user desires to adopt, to identify animals of the breed the user desires to adopt entering a participating shelter with the attributes of a participating shelter from which the user desires to adopt. The system further includes means for notifying the user, through the system website or wireless device application that an animal of the breed the user desires to adopt has entered a participating shelter with the attributes of the participating shelter from which the user desires to adopt.

The system further includes means for actuating the automatic matching means only after a search of the database has ascertained that an animal of the breed that the user desires to adopt is not currently in a participating shelter with the attributes of a participating shelter from which the user desires to adopt.

In accordance with another aspect of the present invention, an internet or wireless device-based, computer-implemented lost and found animal system is provided including a plurality of participating animal shelters housing animals for adoption. The system includes a database containing information about animals available for adoption from the participating animal shelters. Means are provided for posting information, on the system website, about a lost animal. Automatic means are provided for searching the database to determine if the information in the database about animals available for adoption from the participating animal shelters matches the posted information.

The system further includes means for notifying the individual posting the information about the lost animal through the system, if the information in the database about animals available for adoption from the participating animal shelters matches the posted information.

In accordance with another aspect of the present invention, an internet or wireless device-based, computer-implemented lost and found animal system is provided including means for posting information on the system website or wireless device application about a lost animal. The system has means for posting information on the system website or wireless device application about a stray animal that has been found. The system also has automatic means for determining if the information in posted about a lost animal matches the information posted about a stray animal that has been found.

The system also includes means for notifying the individual posting the information about a lost animal, if the information posted about a stray animal that has been found matches the information posted about an animal which has been lost.

In accordance with another aspect of the present invention, an internet or wireless device-based, computer-implemented animal management system is provided including a network of participating animal shelters offering pets for adoption, wherein potential adopting individuals may apply to the participating animal shelters by electronically submitting information on an application. The system includes means by which a participating animal shelter may customize such application by creating questions and answer choices for each question, and by selecting certain of said answer choices; and means for scanning a submitted application to review the answer choices to identify a selected answer choice.

The system also includes means for automatically accepting or rejecting an application containing an identified selected possible answer.

The means by which a participating animal shelter may customize an application by creating questions includes means for specifying whether a question should appear in an application relating to a particular type of pet, means for specifying the order of the questions on the application, and means for creating questions inquiring as to the age of the applicant or members of the applicant's family.

The system of the present invention wherein participating animal shelters provide pets for foster care and utilize volunteers to care for the pets at the shelters, and wherein individuals seeking to foster pets or to volunteer to care for pets at a participating animal shelter may apply to the participating animal shelter by electronically submitting information on an application through the system.

In accordance with another aspect of the present invention, an internet or wireless device-based, computer-implemented animal management system is provided including a network of participating animal shelters offering pets for adoptions, wherein potential adopting individuals may apply to the participating animal shelters by submitting information on an application. The system includes: a database for storing each application and the answers submitted on the application; and means for assigning and storing an indication of the size of the participating animal shelter to which the submitted application is directed.

The assigned size indication is a function of the number of adoptions and the number of returns of the participating animal shelter over a given time period.

The system includes means for providing a template which participating animal shelters of various sizes may use to increase adoptions and reduce return rates.

In accordance with another aspect of the present invention, an internet or wireless device-based, computer-implemented animal management system is provided including a network of participating animal shelters offering pets wherein potential adopting individuals may apply to the participating animal shelters by electronically submitting information on an application. The system includes: means for processing a submitted application through a multiple stage review process performed by at least one staff member of the participating animal shelter to which an application is submitted; means for selecting at least one staff member of the participating animal shelter to which an application is submitted to participate in the application review process; database means for storing documents and notes provided by the selected staff member for association with each stage of the review process for the submitted application; and means for the selected staff member to update the status of the submitted application as the submitted application moves through the review process.

The system also includes means for storing requirements necessary for an application to pass through a stage in the review process, means by which the selected staff member can store documents and notes received from others in the database, means by which any staff member of the participating animal shelter to which an application is submitted other than a selected staff member may access the database to review the documents stored therein and means for automatically assigning one or more pre-selected staff members of the participating animal shelter to which an application is submitted to participate in the application review process.

The system also includes means for a participating animal shelter to upload paper applications created offline to be entered into the application review process, and means for a participating animal shelter to upload any documents to the system for automatic transfer to an applicant's account upon the acceptance of the application of such applicant.

The system wherein the participating animal shelters provide pets for foster care and utilize volunteers to care for the pets at the shelters, and wherein individuals seeking to foster pets or to volunteer to care for pets at a participating animal shelter may apply to the participating animal shelter by electronically submitting information on an application through the system.

The system also includes means for electronically providing information to applicants to assist in transporting a pet from a participating animal shelter to a new location, means for automatically electronically providing information to applicants as to the status of their applications, means for allowing participating animals shelters to automatically preform a background check on an applicant, means by which a participating animal shelter may electronically provide messages through the system to all individuals whose applications have been accepted by that participating animal shelter, wherein the messages may include reminders, check-ins and updates.

The system further includes means by which a participating animal shelter may electronically provide messages through the system to all individuals whose applications have been accepted by that participating animal shelter.

In accordance with another aspect of the present invention, an internet or wireless device-based, computer-implemented animal management system is provided including a network of participating animal shelters offering pets for adoption, wherein potential adopting individuals may apply to a participating animal shelter by submitting information on an application, the system including means for tracking the number of times that an applicant has previously submitted an application, and means for tracking the number of times that an applicant has submitted an application which has been rejected or accepted.

The system wherein the participating animal shelters provide pets for foster care and utilize volunteers to care for the pets at the shelters, and wherein individuals seeking to foster pets or to volunteer to care for pets at a participating animal shelter may apply to the participating animal shelter by electronically submitting information on an application through the system.

In accordance with another aspect of the present invention, an internet or wireless device-based, computer-implemented animal management system is provided including a network of participating animal shelters offering pets for adoption, the system including a database for storing medical information about each pet in a participating animal shelter, and means for automatically sending medical-related reminders to individuals who have adopted pets.

The system includes means for automatically sending medical-related messages about a pet to each adopting individual upon the successful completion of the adoption of that pet by the adopting individual. The medical-related reminders may include a schedule of a medical procedure, information about a single or a recurring medical procedure.

The system further includes a database, means for submitting records of medical procedures for each pet in the care of a participating animal shelter, including information as to the cost of each medical procedure, for storage in the database, and means for tracking the total cost in the database for the medical procedures performed on each such pet.

The system further includes means for providing estimates for the medical care of a pet to participating animals shelters based upon the medical cost information in the database.

In accordance with another aspect of the present invention, an internet or wireless device-based, computer-implemented animal management is provided including a network of participating animal shelters offering pets for adoption and maintaining those pets until adopted, the system includes a database for storing information about the cost of maintaining a pet of a particular type in a participating animal shelter, and means for estimating the typical cost for a participating animal shelter to maintain a pet of that particular type over a particular time period, based upon the cost information the database.

In accordance with another aspect of the present invention, an internet or wireless device-based, computer-implemented animal management system is provided including a network of participating animal shelters offering pets for adoption including means for an adopting individual to receive information about a pet adopted by that individual through the system and means for the adopting individual and the participating animal shelter from which the pet has been adopted to communicate through the system.

In accordance with another aspect of the present invention, an internet or wireless device-based, computer-implemented animal management system is provided including a network of participating animal shelters offering pets for adoption, a database for storing information about a pet adopted by an individual through the system, means for connecting the system to an external pet registry through the internet, and means for transferring information stored in the database to the external pet registry upon command of the individual to automatically register the pet with the external pet registry.

In accordance with another aspect of the present invention, a method is provided for using a GPS microchip associated with an animal and software developed for a smartphone, tablet or internet website which is capable of communicating with the GPS microchip to function as a proximity detector and to alert the owner of the animal when the animal leaves a predetermined area. After selecting a location and a maximum distance from that selected location, same are stored in the smartphone or tablet memory or at an internet website having the software application. The GPS microchip periodically obtains information as to the location of the associated animal and transfers same to the software. The software ascertains the distance between the selected location and the associated animal. It automatically generates a signal if the associated animal is situated at a distance from the selected location greater than the set maximum distance. The software can also provide contact information relating to emergency services proximate the location of the animal, if for example the animal is lost and in need of rescue.

### BRIEF DESCRIPTION OF THE SEVERAL VIEWS OF DRAWINGS

To these and to such other objects that may hereinafter appear, the present invention relates to an internet or wireless device-based, computer-implemented animal shelter management system as described in detail in the following specification and recited in the annexed claims, taken together with the accompanying drawings, in which like numerals refer to like parts and in which:

FIG. 1 is a flow chart of the software relating to the attribute-based breed search;

FIG. 2 is a flow chart of the software relating to the display of live feeds of images of animals available for adoption;

FIG. 3 is a flow chart of the software relating to the creation, access, updating and editing of medical history records;

FIG. 4 is a flow chart of the software relating to the transfer of animals available for adoption between participating shelters;

FIG. 5 is a flow chart of the software relating to the tracking of staff activities;

FIG. 6 is a flow chart of the software relating to the activities of volunteers and fosters;

FIG. 7 is a flow chart of the software relating to the handling of donations and sponsorships;

FIG. 8 is a flow chart of the software relating to the animal lost and found postings and searching;

FIG. 9 is a flow chart of the algorithm employed by the system software to perform a breed search;

FIG. 10 is a flow chart of the software for the breed waiting list;

FIG. 11 is a flow chart of the software for customized application creation and for automated flagging of applications for adoption and fostering;

FIG. 12 is a flow chart of the software for data and status tracking for applications, including automated transfer of adoption documents and automated application status updates;

FIG. 13 is a flow chart of the software for automated template recommendations;

FIG. 14 is a flow chart of the software for automated designation for application review;

FIG. 15 is a flow chart of the software for the automated denied or accepted lists;

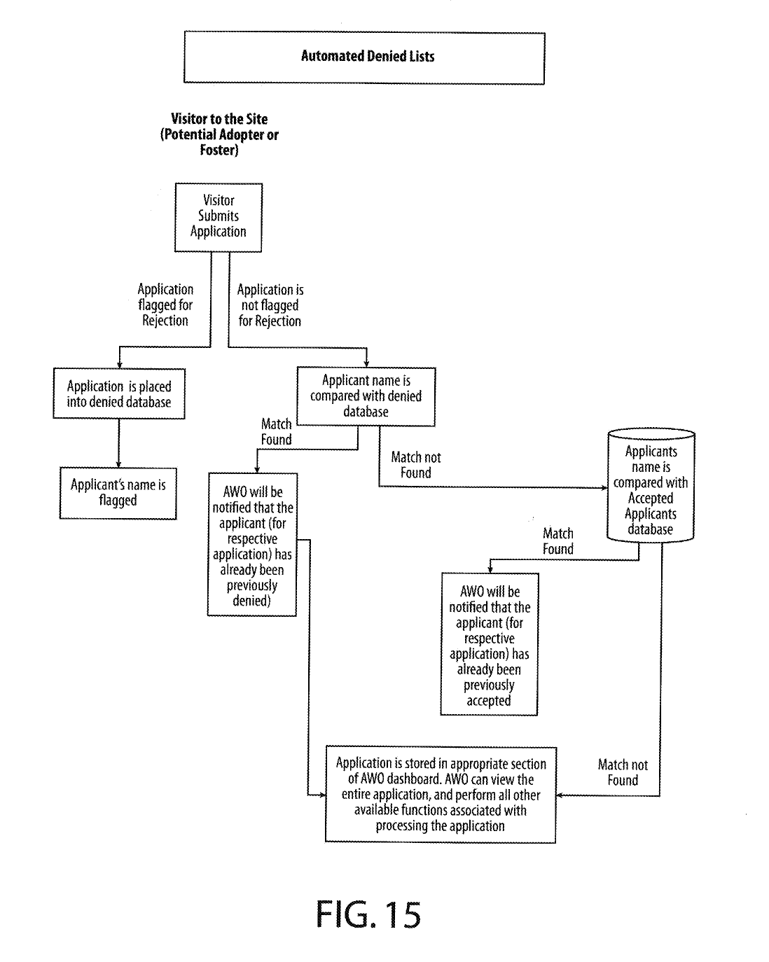

FIG. 16 is a flow chart of the software for automated medical reminders and expense tracking;

FIG. 17 is a flow chart of the software for instant pet registration pet products and services; and

FIG. 18 is a flow chart of the software for a smartphone or tablet application for scanning pet microchips.

### DETAILED DESCRIPTION OF THE INVENTION

The present invention relates to an internet or wireless device-based, computer-implemented animal shelter management system, referred to herein as PerfectAnimalMatch.com (PPM), which includes a plurality of participating Animal Welfare Organizations (AWOs), such as animal shelters. The system utilizes novel management software, as well as a unique user interface, to connect shelters and system users looking to adopt new animals, and provide medical and other pet related information and services, both before and after an adoption takes place.

The following description explains the operation of the system of the present invention as it would be configured for use on the internet using a website, for purposes of illustration. However, it should be understood that the invention could also be configured for use on a wireless network, using wireless communications devices such as smartphones, tablets or the like, running the appropriate wireless device application software by making modifications which are within the ordinary skill of the art. Accordingly, the invention should not be considered to be limited to any particular method of communications between the computers of the system and the system users.

As explained below, the software allows participating shelters to keep track of all financial resources, volunteers, fosters, events, donations, and staff, allowing the shelters to better manage their operations. Additionally, the system assists the shelters by providing the necessary software and hardware to broadcast live feeds of adoptable animals on the system website or wireless device application and automatically send out the list of adoptable animals in the shelter to similar websites, thus increasing online exposure of the animals available for adoption.

Users of the system can easily find an animal to adopt through the unique attribute-based search capability of the software and by watching the adoptable animals in live feeds through the system website or wireless device application, eliminating the need for users to waste time, energy, and money driving to various shelters to review animals available for adoption.

Further, the software helps users to care for their new animal through the post-adoption information tracking center included in the system.

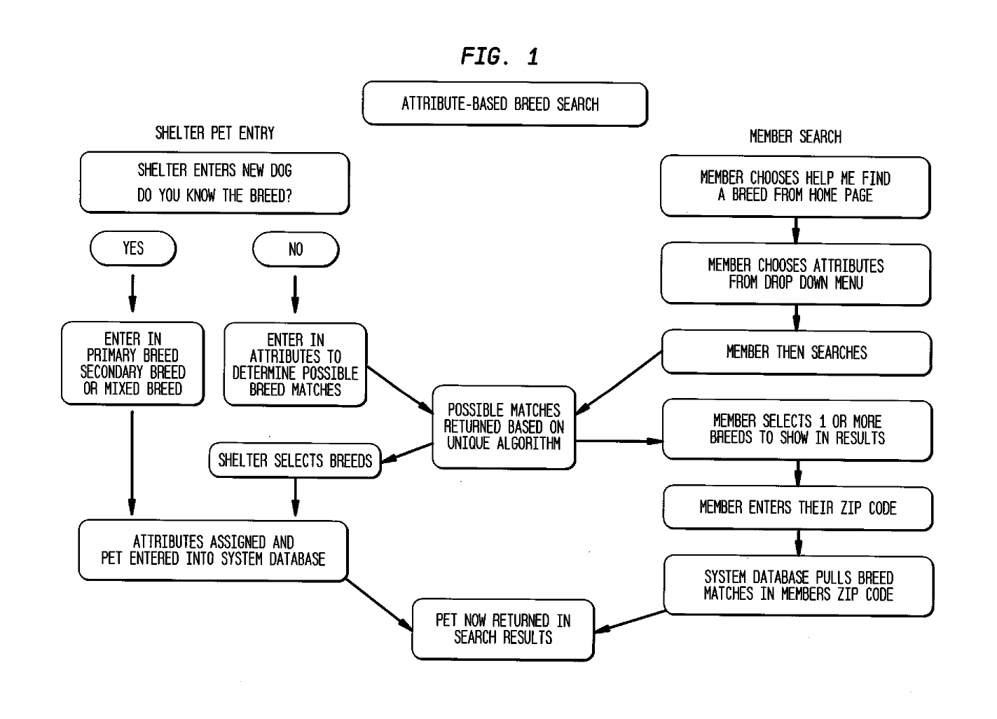

One aspect of the system of the present invention relates to the ability to perform attribute-based breed searches, as illustrated in FIG. 1. That type of search allows a user to choose the breed of an animal the user may wish to adopt, even if the user does not already know the breed of the animal the user wishes to adopt when the user enters the system. This is done by selecting attributes of an animal the user may wish to adopt from a list (dropdown menu) of possible attributes on the system website, such as the type of tail, ears, height, weight, coat, and shedding. Once the attributes are entered, the system automatically searches the system database, calculates a weighted score for each breed, and returns a list of breeds that have the desired attributes based upon the weighted score, along with information about each breed, which information may include an image of an animal of the breed.

This type of search is unlike other animal search sites, which do not assist users in selecting the breed of the animal which the user wishes to adopt. Other sites only let their users filter by breed and then narrow down results by age, gender, color, etc. Accordingly, the user has to know what breed of animal the user is seeking to adopt before the search is performed.

In the present invention, based on the attributes selected by the user, all matching breeds which are available for adoption in nearby participating shelters are returned with the associated descriptions. Users can review the breed information and select the breeds they are most interested in, see specific animals up for adoption using the live feed capability of the system, and narrow down their result even further by gender, color, age, etc. Databases for matching selected attributes with the correct dog breeds and cat breeds may be used.

As is set forth in detail below, the attribute-based breed search can also be used by participating shelters to identify the breed of an animal which they are entering into the system, when the breed is not known to them, as well as by users searching for an animal to adopt but who don't know which breed of animal they want to adopt.

A person that is interested in adopting an animal, but does not know which breed of animal they wish to adopt, enters the system and from the home page selects the page dedicated to helping user identify the breed of an animal they may wish to adopt. The user then selects various attributes from a dropdown menu including weight/size, height, ear type, tail type, whether the animal sheds or not, specialty, coat type, color, and whether or not they want a hypoallergenic breed. Once all attributes are selected, a query is sent to the system and the system automatically searches the database and using an algorithm, which calculates a weighted score for each breed, assembles a list of breeds (and descriptions thereof) with the highest scores matching the selected attributes. That list is returned to the user through the system website or wireless device application. At the same time, the user is advised as to how many animals of each listed breed are available for adoption at participating shelters. This allows the user to select the available breed they most prefer, even if they did not have a particular breed in mind when entering the system and to ascertain whether animals of that breed are available.

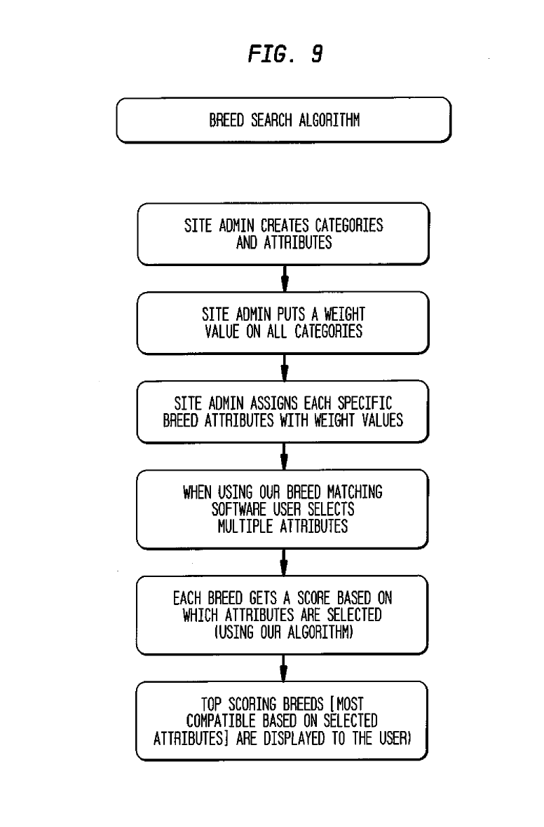

FIG. 9 is a flow chart of the algorithm which the system software employs to perform a breed search. The system administrator creates categories and attributes, and then puts a weight value on all categories and assigns each specific breed attributes with weight values.

When a user using the system breed matching software selects the multiple attributes from the dropdown menu as previously described, the algorithm automatically gives each breed a score based on which attributes selected by the user. A list of the top scoring breeds, which are the breeds which the algorithm determines are the most compatible based on the user-selected attributes, is returned to the user through the system by being displayed on the system website or through the wireless device application.

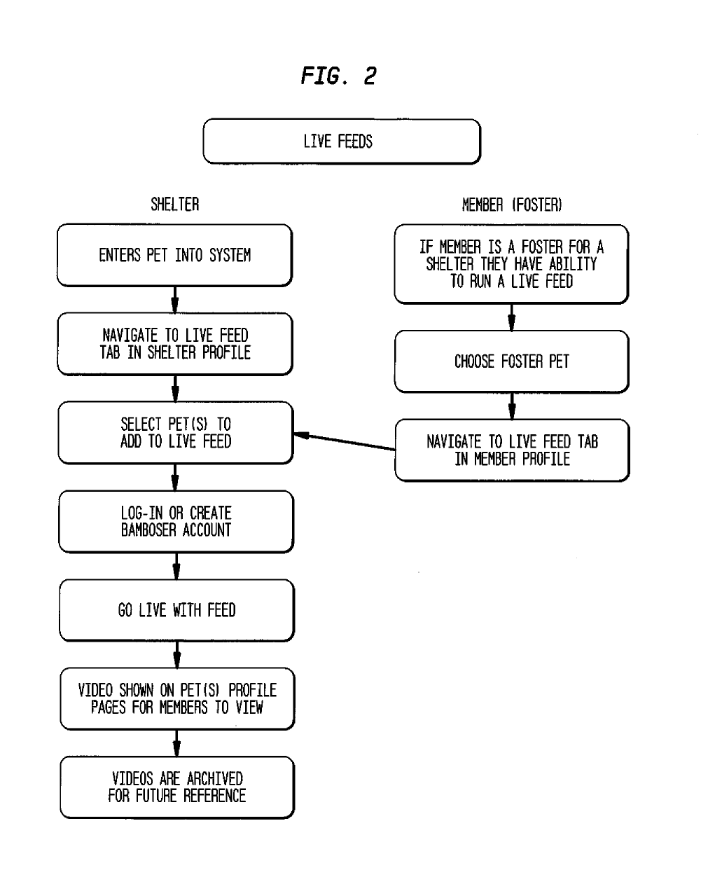

Another aspect of the present invention is the ability of administrator to enter an animal into the system. Thereafter, the administrator or a member associated with a participating shelter, such as a foster, can select the entered animal to be the subject of a live video feed accessible to system users on a webpage associated with that animal, as illustrated in FIG. 2.

When an administrator of a participating shelter enters an animal into the system through the system website or wireless device application, they may or may not know the exact breed of the animal. If they do not know the breed of the animal, the shelter administrator my use the attribute-based search of the system to identify the breed, as follows:
1. The shelter administrator selects the attributes of the animal being entered into the database, as described previously.
2. The attribute search queries the system database and returns a list of matching breeds. From the list of returned breeds, the shelter administrator can select the breed that most closely resembles the animal. If it's a mixed breed, the shelter administrator can select the two breeds that are in the mix, and then can enter in the exact name of the mixed breed (i.e. Cocker Spaniel-Poodle or Golden Retriever-Labrador).
3. The shelter administrator must then enter in the animal's other information, upload a video or a picture of the animal, and write a description.
4. The shelter administrator then has the option to enter the medical records of the animal, which will be stored in the animal medical-records database, as described below.
5. Once all medical records and information for the animal have been entered, a webpage is automatically created for that animal by the system software which contains adoption information, a link which lets a user send in an adoption application, and a section to view all pictures and/or watch a live video of the animal (if the shelter administrator of the shelter chooses to broadcast same through the system website or wireless device application).

If the animal entered by the shelter administrator is selected to be the subject of a live video feed through the system using the system software, the shelter administrator must log into their account, go to the live feed section of their profile, and select the animal(s) the shelter would like to showcase in the live feed. All live videos are recorded so that shelters are able to broadcast short clips of all pets available for adoption through that shelter, if they choose to do so.

After an animal is added to the feed, the shelter administrator can click continue and set up the recording using our integrated live feed software. Once the recording is set up, the system software broadcasts a live feed on all featured animals' profile pages. Since all live feeds are automatically recorded, once the live feed is shut off, people can still view the recorded video of the animal.

Moreover, using the system, a user watching a live video feed can communicate with shelter originating the live feed and request some additional activity, for example that someone at the shelter play with the animal which is the subject of the live feed to enable the user to observe how the animal interacts with a person. The shelter may charge a small fee for this additional service. This allows the user to obtain more information about the animal, such as to ascertain something about the personality of the animal, without having to visit the shelter. If after observing the animal, the user wants to adopt the animal, the user can do so through the system by requesting that the system forward an adoption application to the user through the website or wireless device application.

Another aspect of the present invention, aside from facilitating the animal search, and rendering adoption assistance, is that the system provides a post adoption information center for users. Currently, adoption involves having the user personally visit a shelter before filling out an adoption application. Once at the shelter, an adoption application must be filled out, and (if approved) the person seeking to adopt is given all of the paperwork with the information about the animal, and can take the animal home. For first time animal owners (and even experienced owners) the adoption process can be very time consuming and frustrating. After spending hours getting to the shelter and filling out a long adoption application, the shelter administrator can sometimes reject an application and the potential adopter will be forced to go home and start the entire process again. Furthermore, if the adoption application is accepted and the adoption is processed, the person may not know how to best care of their new animal or may lose the documents given to them.

The present invention eliminates those problems and streamlines the animal adoption process. When a user finds an animal in the system database that he/she wants to adopt, the user is electronically supplied with an adoption application. The user fills out the application, electronically submits the application through the system and waits for approval, instead of going to the shelter and potentially wasting a lot of time and money getting there.

The adoption application available through the system is created by the system administrator to be a generic application which is used by all participating shelters. Accordingly, a user need fill out only a single adoption application, regardless of how many animals the user wishes to apply for, or how many participating shelters the user wishes to apply to during the adoption process.

Once the application is approved and the animal is adopted, the system can process the adoption through the system software, and if the adopter is a registered user of the system, the adopted animal will automatically become associated with his/her system account. If the adopter is not a registered user, an account will be created for that person (once the basic information about the person from the adoption application is entered into the system when the adoption is made) and an email will be sent to the adopter containing all of the animal's important information. The next time the user logs into the system, he/she can access the animal's medical records, adoption records, and microchip information. Additionally, the user will be able to receive advice/tips on how to take care of their animal, starter-kit recommendations to help with buying the right products/insurance for their animal, and will also be able to view reliable animal services in their areas.

In this way, the system of the present invention connects participating shelters having adoptable animals to adopters, and adopters to their animals, during all stages of the adoption process, including after the adoption.

Following is a description of the entire adoption process, as it is performed step by step through the system website:
1. User enters their zip code into the system search and chooses either dog or cat to adopt from the system database.
2. If the user knows the breed they want, they can enter it in the search. If the user doesn't know what breed they want, they can use the attribute-based breed search of the system to determine all possible breeds they may want to adopt.
3. Once the user selects the breed(s) he/she prefers, the user can then select age, gender, and color. As these items are selected, our database returns all adoptable breeds (usually limited to participating shelters within a specified geographic radius) that match the chosen criteria and lists the number of adoptable animals for each breed:
4. Once the user selects “show list of animals” on the system website or wireless device application, he/she will be brought to a page that lists actual animals up for adoption and provided basic information about the participating shelter where the animal is located. The user can then choose the animal he/she wants to adopt, and will be taken to a page where the full profile of the chosen animal is displayed. That page may also show a live video feed of the animal, pictures, a description, etc. about the animal and allow the user to request an adoption application to use to apply to adopt the animal. If the user is able to see a live feed of the animal and he/she can request (through a live chat available through the system) that the participating shelter have someone play with the animal in front of the camera. This feature will allow users to observe the temperament of the animal in a manner not previously possible. This is the way the system of the present invention directly integrates the live feeds into the adoption process.
5. Once the user decides that they want to adopt an animal, they click “apply now” on the system website or wireless device application and the system software will automatically send the user's adoption application to the participating shelter where the animal is located. Since the system uses a generic adoption application, users are able to fill out in their profiles and instantly send the application to any shelter they would like to adopt from.
6. Once the participating shelter receives the adoption application, the administrator of that shelter can decide whether to preliminarily approve or reject it. If the application is approved, the user will be notified of the approval through the system's messaging service. The user can then schedule a time to meet with the shelter administrator and see the potential animal in person. If the application is rejected, the shelter administrator may, if he or she chooses, communicate with the user through the system and provide an indication as to the reasons why the application was rejected. The user will then have to apply to adopt an animal from a different shelter.
7. Once the user schedules a time to visit the participating shelter where the chosen animal is located, the user must travel to the shelter and finalize the adoption. At that time, the shelter administrator may do an additional assessment (if needed) and can then process the adoption in the system.
8. If someone who applied through the system completes an adoption, the shelter administrator will be able to select the animal that is up for adoption and click “Process Adoption” on the website. If there is an adoption application associated with that animal (i.e. electronically sent by the adopter through system) the person's information will automatically be entered into the appropriate fields on the webpage or wireless device application. If the person is an outside (unregistered user) adopter, these fields must be manually entered by the shelter administrator. Once the fields are filled out, the shelter administrator must then fill in the animal's micro-chip information and any additional medical records associated with the animal that have not already been entered. Once this is done, the shelter administrator clicks “Finalize Adoption” on the system website or wireless device application.
9. If the adopter is already a registered user, the animal will automatically become associated with that user's account. The system software associates the animal with the adopter using the adopter's email address. The adopter can then log in to their account and see all of the animal's important information (adoption contract, microchip info, animal insurance info, medical records, etc.), can view deals on animal products, and can even get tips/answers on how to take care of their new animal. If the adopter is not currently a registered user, the system software automatically sends all of this information to that person's e-mail address. If the adopter does not have an e-mail address, they may request the information be printed and mailed to them. The e-mail will let the adopter know that the system has all of their information stored in its database and that they can create an account for free (no e-mails or spam will be sent to them) by entering in a password. If they opt not to create an account, they can just print the information and choose to complete the sign up process at a later date.
10. Once an animal is associated with an adopter, the system software can then provide tips and eventually veterinarian recommendations. Users can continue to track and update their animal's medical records and other information. The present invention is the only system which has a web site that allows a new animal owner to track a newly adopted animal online to this extent.

The post adoption software provides a single database, accessible from any internet- or wireless connected device, at any time, in which a person can conveniently store all information about their animals. Further, the system software automatically creates an account for anyone who adopts through the system. It e-mails the adopter all records associated with their animal. It stores and gives the adopter access to all of the records of the animal from a single location. Moreover, the system databases are set up and linked so that a user can instantly populate all of the databases with important information.

Further, set forth in detail below, the system software creates a portal where shelter administrators and veterinarians can log in and update medical information for each animal on the system website or wireless device application. Anyone with proper access can see the medical records, micro-chip information, animal insurance, supplies, vet information and everything else associated with taking care of their animal, all at a single, easily accessible location.

Another aspect of the present invention relates to the medical record database which stores the medical history of the adopted animal. The medical records database of the system will keep track of all medical histories of any animal in the system. Currently, no online or wireless accessible database for animal medical records exists. As a result, veterinary hospitals have to spend a lot of time calling other vets to get medical records of new animals which they do not have and once obtained, have to enter the new medical records into their systems. The present invention streamlines that process.

Using the system, veterinarians are able to log into the system database and quickly update or access information about specific animals. Also, administrators of participating shelters will be able to update all medical records for each animal (as long as that animal is still being cared for by the shelter) so that once the animal is adopted; both the animal owner and that animal owner's vet will have instant access to the animal's information.

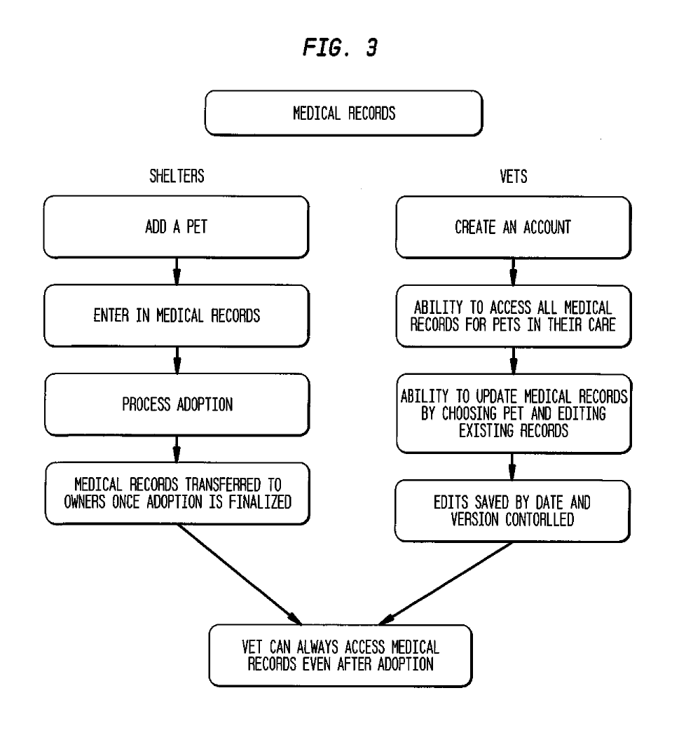

This portion of the system software is illustrated in FIG. 3. The following is an explanation of how this portion of system software operates.

### For AWO's and New Adopters:

1. The administrator of a participating shelter logs into the account of the shelter on the system (accessing the system database) and enters in all medical records for every adoptable animal. Based on feedback from veterinarians, the system administrator has designed a different generic form for each type of medical record (anesthesia form, general health form, medication records form, etc) in order to make this process as easy as possible.
2. Once the information is entered, it is stored in system's secure database and can be accessed by registered users of the system who want to view their animal's information after the adoption is completed.
3. The user will now be able to print out the medical information in the database and bring that medical information to their new vet.

### For Vets:

4. A veterinarian will be able to have their own account (by subscribing to the system) in order to view, edit, and create medical records for all animals under their care that are listed in the system database.
5. Vets will be able to access this database online, and must log in to view all medical records associated with animals in their care.
6. If a vet wants to update a medical record, he/she must first click on the animals name and then enter in the new medical record, or edit an existing record.
7. Any changes made to an existing record will be noted by date, and previous records will be saved (if the vet chooses to do so) so they can track all changes for each record.
8. If a vet needs to access past medical records for a new animal, they can enter in the owner's name, address, phone number, the name of the animal, or the owner's key. The owner's key is given to all owners who adopt through the system and will allow the vet to quickly bring up all animal records for each animal for that specific owner. Once the required information is entered, any medical records associated with animals of that owner will automatically become accessible.
9. Since medical records for animals are not required to be private, this will be a shared database. Therefore, as long as the veterinary hospital has the information required in the previous paragraph, they can instantly access and update that animal's medical records as long as that animal is already in the system.
10. A vet can add any animal not in the system or in a participating shelter by logging into their system account, clicking “add new animal,” and then submitting the required information. Once the animal is in the system, the medical records can be updated.

Using the system, shelter administrators can enter the medical histories of each animal in their shelter into the medical records database. Shelter administrators, vets and animal owners can log into the system and track all of their animal's medical records, expenses, tests, results, and any other information related to the medical history of their animal from a single location. It also allows the information in the medical records database to be forwarded quickly and

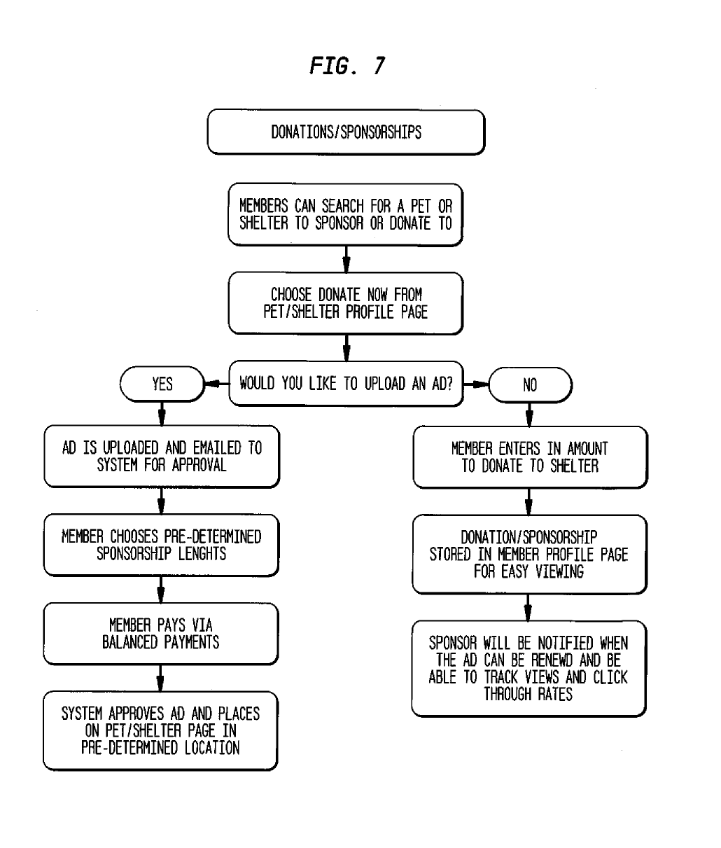

Another aspect of the system of the present invention is that it provides for automatically sharing revenues from advertising, donations and sponsorships with the participating shelters through the Donations/Sponsorship pages of the system, as illustrated in FIG. 7.

Through each animal's page, and each shelter's main profile page in the system, anyone (from local sponsors/businesses to users on the site) may purchase an advertising slot and post an advertisement (upon review/approval). The revenues from these advertisements are shared with the participating shelters. The revenue sharing may take place through a website called “Balancedpayments.com.”

This allows people to enter the system and upload their ad to the system and once approved have the ad posted immediately, without personally contacting the system owner. It also allows participating shelters to receive donations through the system without having to pay for payment processing software.

Following is a step-by-step explanation of how sponsors and users can post an ad to an animal's page:
1. The user/sponsor logs into their account and clicks the button to “sponsor an animal”. They are then taken to a page where he/she can search for the animal to be sponsored.
2. There they can search for an animal up for adoption and choose to sponsor the animal, enter in their payment information, and confirm the cost of posting an ad. The system can set a maximum number of days during which the ad will appear and will charge an amount for that period, which may be calculated for each day, bi-weekly, etc.
3. Once payment information is confirmed, the user/sponsor may upload their ad. The system administrator must approve the ad before it appears on the website or wireless device application, which may be, for example, in the lower right hand corner of the selected animal's or shelter's page.
4. After the animal is adopted, the page will be removed and the ad will be removed. The user/sponsor will be charged for the days not yet paid for and a notification e-mail will be sent to them letting them know the ad has been taken down.
5. Once the max number of days for the ad has been reached, the user/sponsor will be notified via e-mail and can renew the ad. The system will also have an auto-renew option for the user/sponsor to select as well.
6. Users/sponsors will be able to track the number of views and click through rates in their accounts.

Another aspect of the present invention relates to the transfer of adoptable animals between participating shelters. Currently, shelter personnel must go to other shelters and request to transfer an animal. The receiving shelter must fill out documents offline and complete the process manually.

The system of the present invention automates this process by providing each shelter with access to an electronic transfer form through the system. It also allows the transferring shelter to approve or deny a transfer request electronically. Further, it allows participating shelters to search through the system database to locate transferable animals.

The system allows participating shelters to search for transferable animals via zip code, fill out and send all necessary paperwork electronically, and then schedule a time for examination/pick-up, saving the shelter time and money. Since all of the transfer documents are created and saved in a secure location within the system, the shelters will always have access to past records if needed.

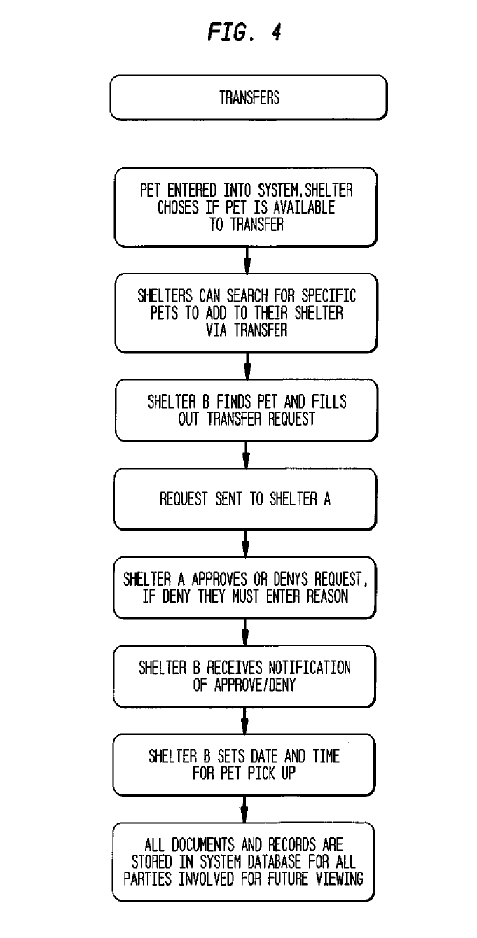

Following is a step-by-step explanation of the transfer process, which is illustrated in FIG. 4:
1. When a participating shelter enters an animal into the system, the shelter administrator can select whether or not the animal is transferable. Any animal selected as transferable will automatically be included in the system database for transferable animals.
2. If another participating shelter wants an animal transferred to its facility, they log into their account, and proceed to the “Transfer” section of the website or wireless device application.
3. Shelter personnel can then search for all animals up for transfer within a specified zip code or a given mile radius. The shelter can then narrow down the type of animal by breed, age, gender, or color.
4. Once an animal is selected for transfer, the transferring shelter can instantly forward all documents required to transfer to the animal. Generic transfer applications created by the system administrator are available electronically to the shelters for transfer purposes.
5. After the transferring shelter receives the application with the transfer request, the administrator will review the request and can deny or approve the application.
6. If the application is denied, the transferring shelter administrator can state reasons why it was denied and send the message back to the shelter that applied to transfer the animal. If the application is approved, the transferring shelter can then schedule a time/day to pick up the animal being transferred.
7. All documents and records are stored in the system's database and can be accessed by all participating shelters involved in the transfer process any time they are needed.

Another aspect of the system of the present invention is that it provides the ability for shelter administrators to manage the volunteers, fosters, and staff associated with their shelter. This is achieved in part by providing an online or wireless device system through which shelter administrators can communicate and interact directly with the volunteers, fosters and staff associated with their shelter and allow them to use the system to run live animal feeds, update important information in the system database remotely, and to create and schedule events. Further, it allows shelter administrators to accept/reject applications, send messages directly to the applicant, talk to fosters and volunteers via the system's internal chat rooms and messaging system, as well as to assign staff members to certain fosters and volunteers to manage them.

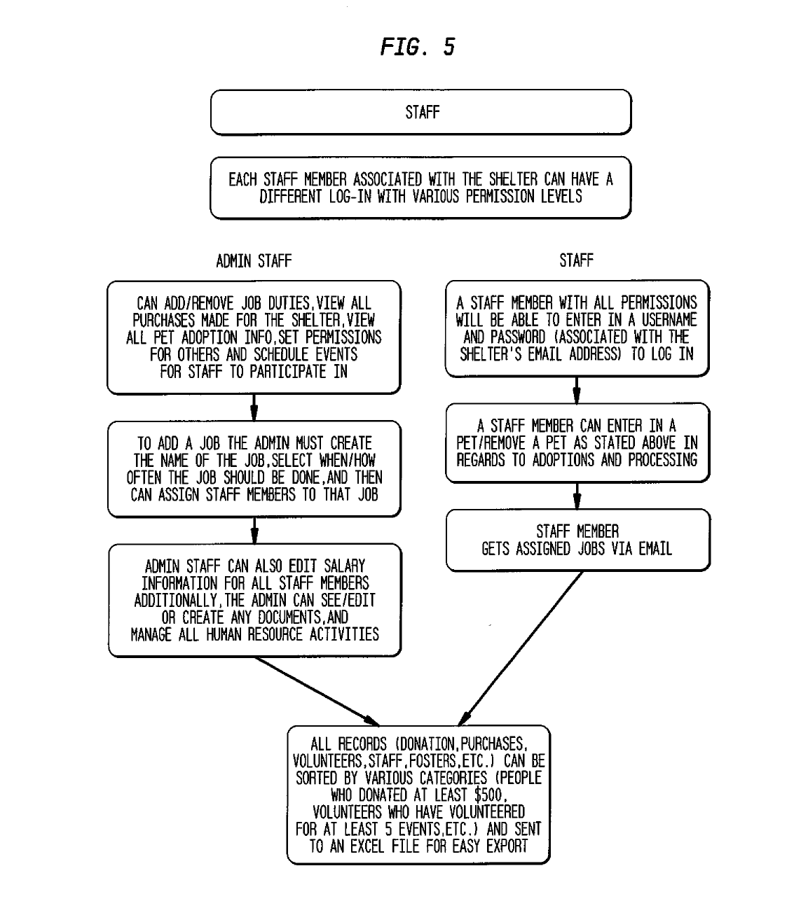

For staff, as illustrated in FIG. 5, the shelter administrator can identify job duties, record when a staff member makes purchases on behalf of the shelter, keep track of salary information, and even assign staff to certain events.

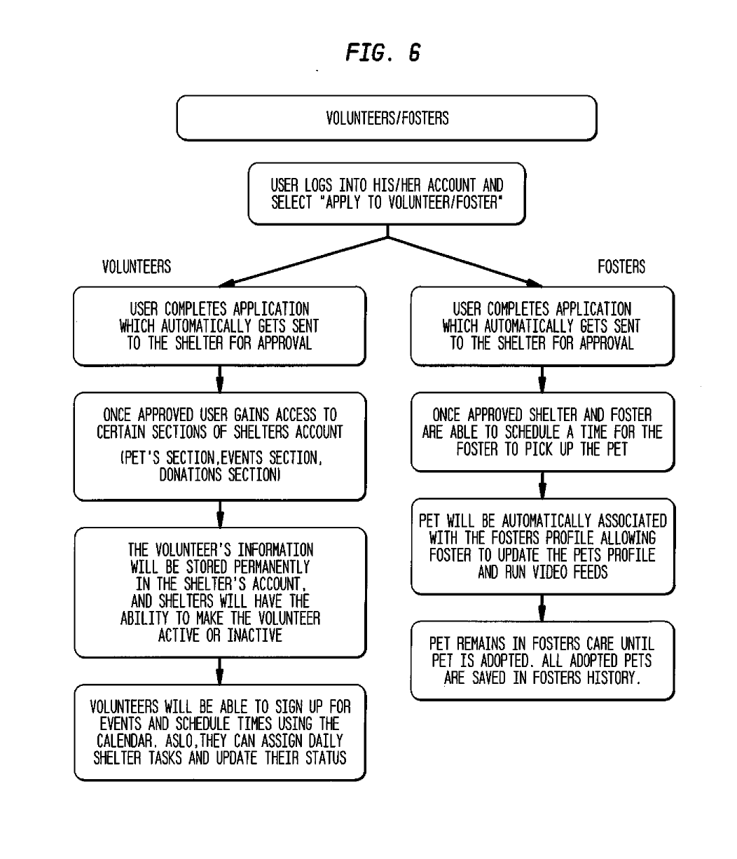

For volunteers and fosters, as illustrated in FIG. 6, the system lets fosters/volunteers send in applications electronically, allow fosters/volunteers to use a calendar to sign up for shelter sponsored events electronically through the system, allows the shelter to keep track of all past events and times people volunteered for, and allows the shelter to keep track of how much their fosters/volunteers donated and contributed over time.

Further, for fosters, the system allows the shelter administrator to keep track of all of the fosters associated with their shelter, lets their fosters post live videos of the animals that are being fostered, and lets the shelter administrator see exactly who is fostering each animal using the system online or wireless device application interface.

Following is a step-by-step explanation of how the system software helps shelter administrators manage and interact with their volunteers, fosters and staff.

### Volunteers/Fosters:

1. A register user of the system will be able to apply to any participating shelter through the system website or wireless device application in order to become a volunteer or foster an animal. To start the process, the registered user simply logs into his/her account and selects “Apply to Foster/Volunteer” on the system home page.
2. Since the system has already includes generic foster and volunteer applications in the system database for use by all participating shelters, the application is filled out by the registered user and automatically forwarded to the shelter involved for approval.
3. If the application is approved by the shelter administrator, the applying foster/volunteer becomes associated with the account of the shelter. The shelter will be able to track all information regarding the foster/volunteer and the shelter administrator can set permissions through the system website or wireless device application related to which information in the system database the volunteer/foster is allowed to update.

### Foster Approval:

4. If a foster's application is approved, the shelter administrator and the foster are able to schedule a time for the foster to pick up the animal to be fostered from the shelter. Additionally, the animal will automatically become associated with that registered user's account in the system database. This will allow the foster to edit the animal's details (if the shelter administrator gives the foster permission to do so) and to run a live video feeds of the fostered animal.
5. The animal will remain associated with the registered user's foster account until the animal is adopted, or the shelter administrator asks the foster to return the animal. Once the animal is no longer in the care of the foster, the shelter or foster can advise the system of same by clicking the appropriate button on the system website or wireless device application. When that happens, the animal will go into the registered user's archive of past fostered animals and the foster will be moved to the archived foster section of the shelter's account (which is the section that stores all information and dates of people who have fostered animals for the shelter in the past).

### Volunteer Approval:

6. If a volunteer's application is approved, the volunteer will be able to access certain sections of the account of the shelter the volunteer will be associated with, depending upon the permissions given to the volunteer by the shelter administrator. For example, the shelter administrator can allow the volunteer to access and edit the animal's section, the events section, the donations section, and any major section associated with its account.
7. Once permissions have been set, the volunteer can log into his/her account and gain access to the necessary sections in order to make updates and help the shelter administrator.
8. The volunteer's information will be stored permanently in the shelter's account, and the shelter administrator will have the ability to make the volunteer active or inactive. An active volunteer is a volunteer who can make changes to the shelter's account (based on the permissions given). An inactive volunteer is a volunteer who is no longer associated with the shelter and cannot access the shelter's account information or make changes.
9. Volunteers will be able to sign up for events and schedule times using the events calendar. To do this, the volunteer can enter the system and create or click on an event, click on an open task, select an open time slot for that task, and then confirm the volunteer times/days. A volunteer can also go through the same process for daily shelter volunteer tasks, such as cleaning kennels, walking dogs, feeding the animals, etc.
10. The shelter administrator will be able to leave feedback on the page of the volunteer by selecting a star rating (0-5 stars) and leaving comments, if they choose to do so.

### Staff.

1. Each staff member associated with a participating shelter can have a different log-in with various permission levels. For example, the Executive Director of the shelter will be able to see all sections, including sensitive information such as salaries and resumes. A junior staff member may only be able to edit events and add animals to the system.
2. A staff member with all permissions will be able to enter in a username and password (associated with the shelter's e-mail address) to log in to the system.
3. Once logged in, the shelter administrator can add/remove job duties (and assign jobs to certain staff members), record each purchase made on behalf of the shelter by the staff member, view and edit salary information, view donation information for all donors, view all animal and adoption information, view all volunteer or foster information, view all documents associated with each staff member, set permissions for other staff members, and can assign staff to events or assign them volunteers to help them with particular tasks.
4. To add a job, the shelter administrator must create the name of the job, select when/how often the job should be done, and then can assign staff members to that job. The shelter administrator can also give feedback (0-5 stars with comments) to each staff member on the job and this will go to that staff member's inbox the next time they log in.
5. To record a purchase, the shelter administrator can record the name of the item purchased, the price, the reason for purchase (category), and the date purchase. All purchases will be stored in the shelter's account in the system and can be accessed any time the shelter administrator needs to access necessary information.
6. To edit salary information, the shelter administrator will be able to view all staff members and select a specific staff member. Once selected, the administrator can see/edit/create any documents, tasks, and salary info associated with that specific staff member.
7. Any donation made to the shelter will automatically be recorded in the donations section for viewing by any staff member with the correct permissions. This goes for any volunteers and fosters associated with the shelter, as well.
8. A staff member can enter an animal in or remove an animal from the system, as stated above in regards to adoptions and processing.
9. The shelter administrators are able to set all permissions by going into the admin settings section of his/her account and choosing a specific foster, volunteer, or staff member. Once selected, permissions can then be set for that specific account.
10. To assign an event to a staff member, the shelter administrator can enter the system, select the event, click assign staff members, and then assign tasks to each staff member. The administrator can also edit the staff member area and assign events/tasks to a specific staff member.
11. To assign a volunteer to a staff member, the administrator can enter the system, select the staff member, go to the volunteer associations area, select the task/event which the staff member is responsible for/or has created, and then select all volunteers associated with that task.
12. All records (donations, purchases, volunteers, staff, fosters, etc.) can be sorted by various categories (people who donated at least $500, volunteers who have volunteered for at least 5 events, etc.) and sent to an excel file for easy export.

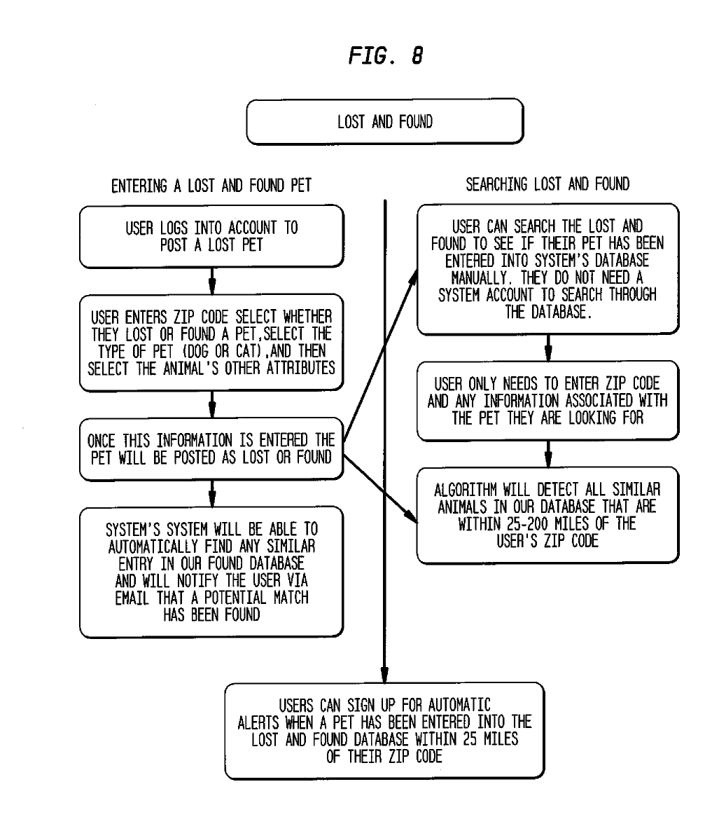

Another aspect of the system of the present invention is that it can serve as an electronic “lost and found” to help reunite lost animals and their owners, as is illustrated in FIG. 8.

When an animal is lost, people tend to send out email blasts to friends or post on social networks or search every so often in various lost and found databases on the web. However, prior to the system of the present invention, there has never been a database where people can post information about an animal that they have lost or post a stray animal that they have found, and where the system can automatically search the website to ascertain if there is a previously posted animal on the website that matches their post, and further can automatically e-mail the poster that a match has been located.

The system will list all lost animals in the database for free. If a person has lost an animal, he/she can post it in the “lost and found” database of the system and the system software will send out an email blast to all registered users (if they choose to “opt-in”) within 50 miles of the zip code of the person posting the information. Additionally, if a person has found a stray animal, he/she can post it in the “lost and found” database, which will allow the person that lost the animal to easily find it. Once someone finds their lost animal in the database, they are able to send a message to the person who posted the animal, and arrange for pick-up.

Following is a step by step explanation of how people can post and search for lost/found animals in the system database:

Entry into the Lost and Found:
1. A registered user must first log into their system account in order to post an animal to the system lost and found database.
2. When posting a lost/found animal, the user enters in their zip code, select whether they lost or found an animal, select the type of animal (dog or cat), and then select the animal's other attributes (age, color, gender, breed, description of the animal), and may upload a picture of the animal.
3. Once this information is entered, the animal will be posted as lost or found.
4. If it is a found animal, people looking for their lost animal can find it by searching through the system lost and found database (explained below). If a lost animal has been entered with similar information, the user will be automatically notified immediately and can see if it is an exact match by clicking on the similar entry returned to the user. The user entering an animal must have a system account for this capability to be enabled.
5. If it is a lost animal, the system software will be able to automatically find any similar entry in our found database and will notify the user via e-mail that a potential match has been found. Additionally, it will send out an e-mail to all users within 0-25 miles (registered users on the site can opt in to help others find lost animals) containing the lost animal's information and notify them to be on the lookout. The user entering an animal must have a system account for this capability to be enabled.
6. If an animal is listed, it will automatically be removed from search after a predetermined period, for example, 60 days) if the user doesn't manually remove the animal once it is found. The user will be automatically notified by the system via e-mail that the animal has been removed and the user can choose to repost the animal by clicking a “re-post now” button on the system website or wireless device application.

### Searching the Lost and Found:

7. A person can search the lost and found to see if their animal has been entered into the system database manually. They do not need to be a registered user to search through the database.
8. The person only needs to enter in their zip code, and any information associated with the animal they are looking for (breed, color, age, etc.) into the system.
9. Once this information is entered, an algorithm which is part of the system software will search for a match and identify all similar animals in the system database that are within a given distance (for example, 25-200 miles) of the person's zip code (the number of miles depends on what the person selects). Since a person entering in the animal may enter in some information incorrectly, the system software is constructed such that it compares attributes but does not exclude non-identical matches from the search results.

### Finding a Match:

10. If a person finds a match, or is notified of a possible match via e-mail, that person can then message the person who posted the animal through the system or via e-mail and arrange to pick up the animal
11. Once the animal is retrieved from the person who found it, the owner can confirm the animal was returned to its owner by logging into their system account and selecting “animal has been returned to owner” in the system. The animal will be then removed from the lost and found database, and archived in system database as a successfully found animal.
Although anyone can create a lost and found for animals, no lost and found automatically alerts the user if a potential match has been found. The system of the present invention does this by allowing users to enter in attributes of both lost and found animals. For example, a lost adult male animal in the zip code 10016 is entered into the system. This animal's information is stored in the “lost” portion of the database. If someone finds an adult male within the same zip code and enters it as a found animal (thus the information for this animal will be put in the “found” portion of the database, odds are it will be the same animal that was entered into the “lost” portion of the database. By comparing the entries in the “lost” portion of the database to the entries in the “found” portion of the database, the system will be able to identify this potential match by comparing attributes, and automatically alerts both parties of the potential match.

This is a vast improvement over conventional lost and found systems where the user has to look for a match manually by searching through a database that only contains lost animals. which is incredibly time-consuming because they may enter in the wrong attributes, or may overlook returned results. The system of the present invention solves this issue by alerting the user of “similar” matches in the “lost” portion of the database and “found” portion of the database, so even if the users entered in slightly different attributes for the same animal, a match can still be found.

Another aspect of the present invention is to provide a system that will automatically match an animal to a user on the site. The user will fill out a profile sheet (do you live in a house? have kids? what type of animals do you own? are you at work all day? etc.) and then, from the information recorded, the site will populate a list of best-match animals.

Also, a person searching for an animal may find that the breed they are looking for is not available on various animal search sites. As a result, they turn to breeders. This causes shelters to become overpopulated, which results in an increase in euthanasia rates.

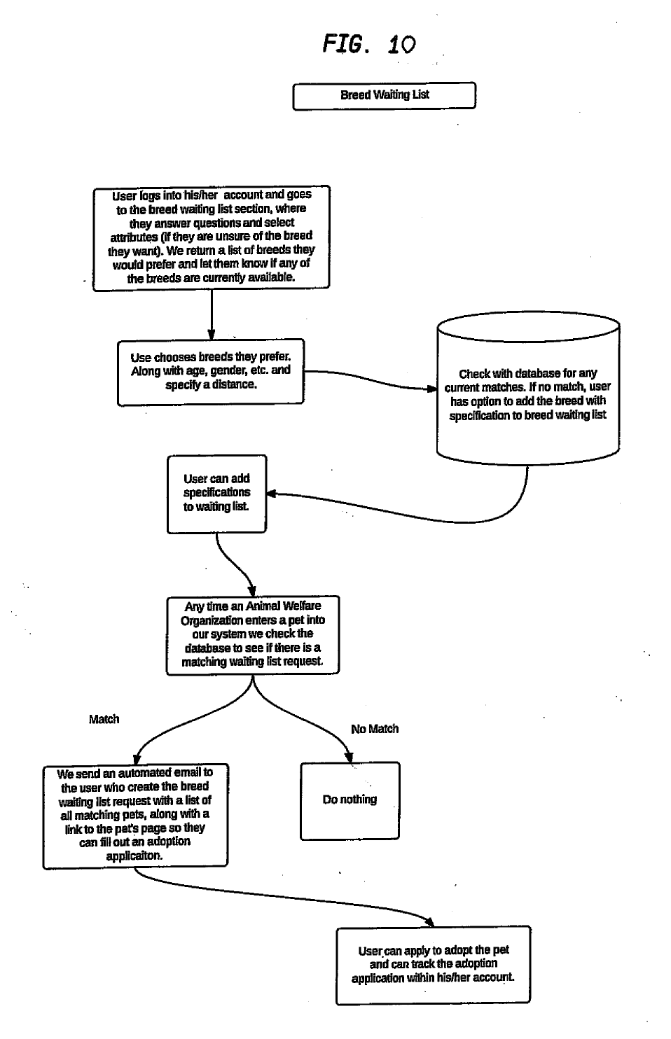

To help alleviate this problem, the software in the system has been configured to maintain breed waiting lists. As illustrated in FIG. 10, using this part of the software, users can request breeds they are looking for and if that breed becomes available for adoption within a specified radius of their zip code, the system will automatically notify the user via e-mail. The user can then adopt the dog or cat they have been patiently waiting for without having to waste time searching multiple animal search sites or spending extra money buying from a breeder.

Following are the steps associated with this process:
1. User logs into his/her system account and goes to the animal questionnaire section.
2. The user answers all questions in the questionnaire (examples stated above) and also selects attributes from the attribute-based breed search.
3. The user can then see all breeds that best fit for the answers given to the questionnaire.
4. From here the user can select which breeds he/she wants to adopt (can also include breeds not returned by the questionnaire) and then narrow this down by age, gender, color, etc.
5. Once this information is entered into the system through the website or wireless device application, the user will be emailed with an exact animal and a link to that animal's page as soon as a matching animal becomes available for adoption at a nearby participating shelter. The user can receive notifications of possible matching animals up to 200 miles away.
6. Once a recommended animal is e-mailed to the user, he/she can then see the animal's information and apply to adopt the animal immediately (on a first come first serve basis).

Accordingly, once a user enters the breed(s) they want to adopt, the system allows users to automatically be alerted when the specified breed(s) becomes available, within a given geographic radius. This is this by combining a request database (which lists breeds that different users request) with the system animal database. If a zip code and breed match are found, the system notifies that user via e-mail automatically and provides them with the adoption application immediately.

Moreover, the system of the present invention can suggest an ideal animal for the user based on responses by the user to questions formulated and forwarded to the user by the system. This is done by creating a database that matches answers to each question with each breed. For example, a Golden Retriever would be matched up with yes, no, yes (respectively) to the following three questions:

Do you like big dogs?
Do you like dogs that shed?
Do you have any children?
Thus, any user who answers, yes, no, yes to those questions will likely have a Golden Retrieve as one of their ideal animals. There will also be other similar breeds/animals returned as well The system may also ask additional questions such as “Do you have kids?” or “Do you have any other animals?” Since each individual animal has its own description, which the shelter enters into the system manually (ok with kids, ok with dogs, ok with cats, etc.), the system can utilize an algorithm in the software which matches adoptable animals to a user based on the user's answers to our questions.

The system of the present invention has fully customized application software which has complete tracking and documentation capabilities including automatic rejection and/or flagging of applications.

The system provides Animal Welfare Organizations with the ability to create their own customized adoption, foster, and volunteer applications. While creating the answer choices to each question in their custom applications, the AWO can pick which answer choices (if selected) will raise a flag or automatically reject the application. Additionally, the software will help the AWO to optimize the application process by keeping track of return rates for different types of applications/processes and recommending templates that Animal Welfare Organizations of different sizes can use to increase adoptions and lower return rates. Further, the system software will allow AWOs to track all documents and all notes associated with each part of the application approval process. It will allow an AWO to automatically send all documents to the adopters/fosters/volunteers upon approving the applications. It will also keep track of the entire application history and pet history any time an update is made to a pet or an application.

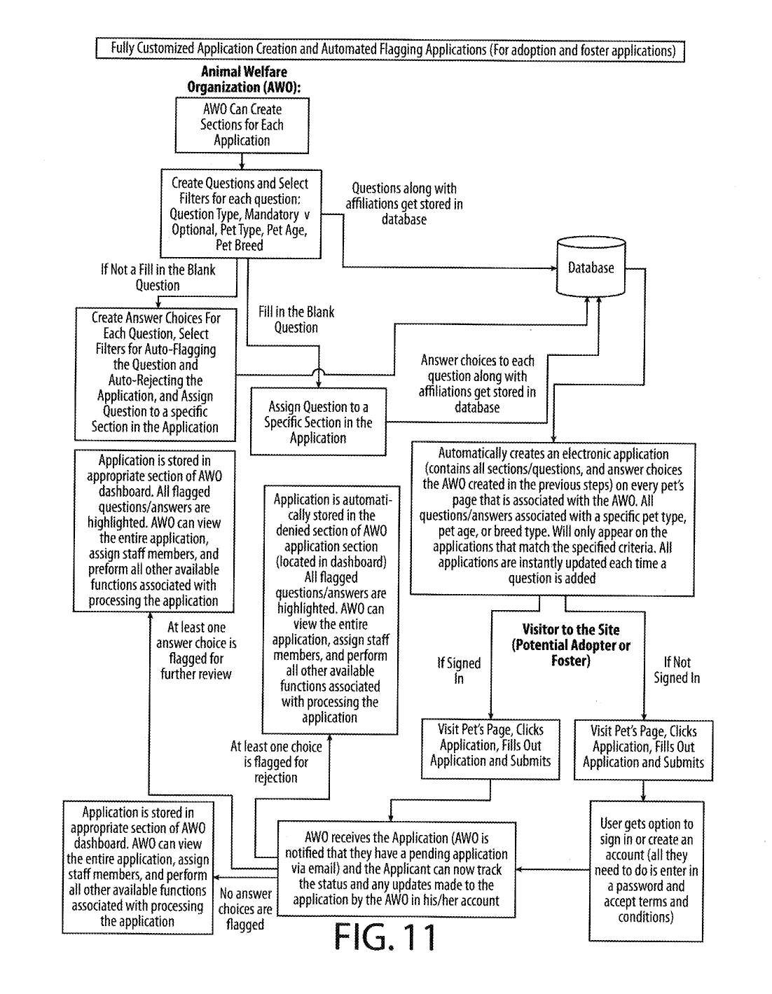

FIG. 11 illustrates the above in greater detail:

A. Fully Customized Application Creation: AWOs can create their own customized adoption, foster, and volunteer applications and can specify if they want each question to appear in dog applications or cat applications only. They can specify age ranges and breed types they would like each question to appear on (i.e. If they have a question “Do you have any other puppies?” they can ensure that question only shows up on dog applications for puppies). They can rearrange the order of each question on their application however they would like.

An AWO can create each section of its application. It can create the questions and filters for each question, by specifying the question type (mandatory or optional, pet type, pet age, pet breed etc.) The questions along with affiliations are stored in the system database. If the question has a fill in the black answer, the question is assigned to a specific section of the application and stored in the database. If the question has a fill in the blank answer, several possible answers are created and stored in the database.

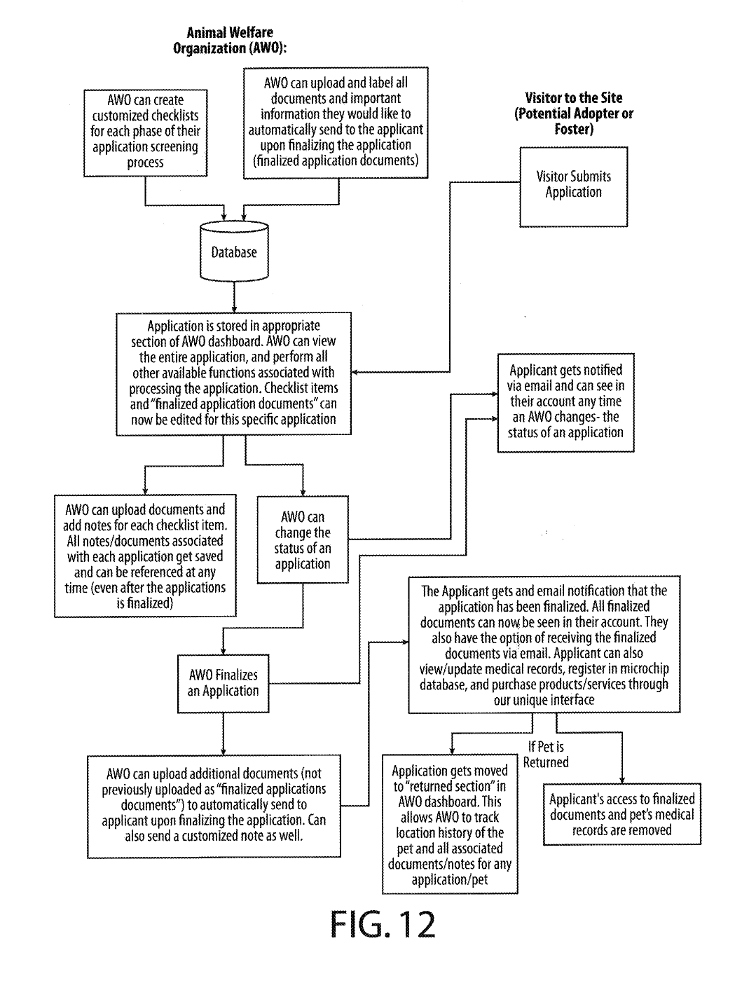

B. Automated Flagging of Applications: This feature also allows AWOs to pick which answer choices will raise a flag or to auto-reject the application. The purpose of doing this is to save time from having to read through an entire application only to find that the application must be rejected because a question towards the bottom of the application was answered unfavorably. The system software automatically scans submitted applications and highlights answers that are flagged for further review. Applications flagged for rejection are automatically placed in a denied application database. This allows the AWO to quickly scroll through an application and instantly select the items they need to look into.
C. Complete Data Tracking for Processing Applications: As illustrated in FIG. 12, Animal Welfare Organizations can create a customized checklist for their applications so they can keep track of all documents and all notes associated with each part of the application approval process. Usually AWOs process applications in 3-4 steps (Initial Application Review, Home Visit, Additional Screening, Final Application Approval).

Using the system, the AWOs can change the status of any application with the click of a button. This helps each application to move along the application review process. Under each of these steps, AWOs can create tasks they need to accomplish (i.e. obtain proof applicant lives at the address written in the application) and upload documents associated with each task. Staff can also leave notes for each task in the database and check off each task as it is completed. All notes and documents uploaded for each individual task are saved indefinitely so the AWOs always have a record of the important documents needed to process each application.

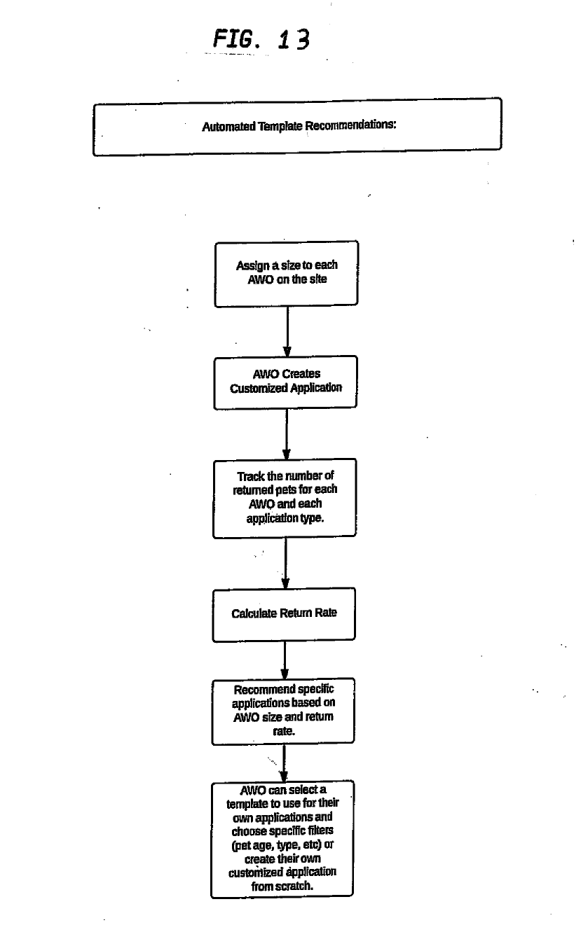

D. Automated Template Recommendations: As illustrated in FIG. 13, providing template recommendations also helps AWOs optimize the application process by keeping track of return rates for different types of applications/processes and recommending templates that Animal Welfare Organizations of different sizes can use to increase adoptions and lower return rates.

All applications created by the AWOs are stored in the database. A size is assigned to each organization (big, medium, small, etc.) based on number of annual adoptions, adjusted by the number of adopted pets that are returned (the system tracks each time a pet is returned). At end of year, the system divides the return count by the total number of adoptions for each AWO and determines which AWOs had the lowest return rate. Based upon the applications used by several of the most successful AWOs in each size category, application templates are created and provided to the AWOs in each size category upon request.

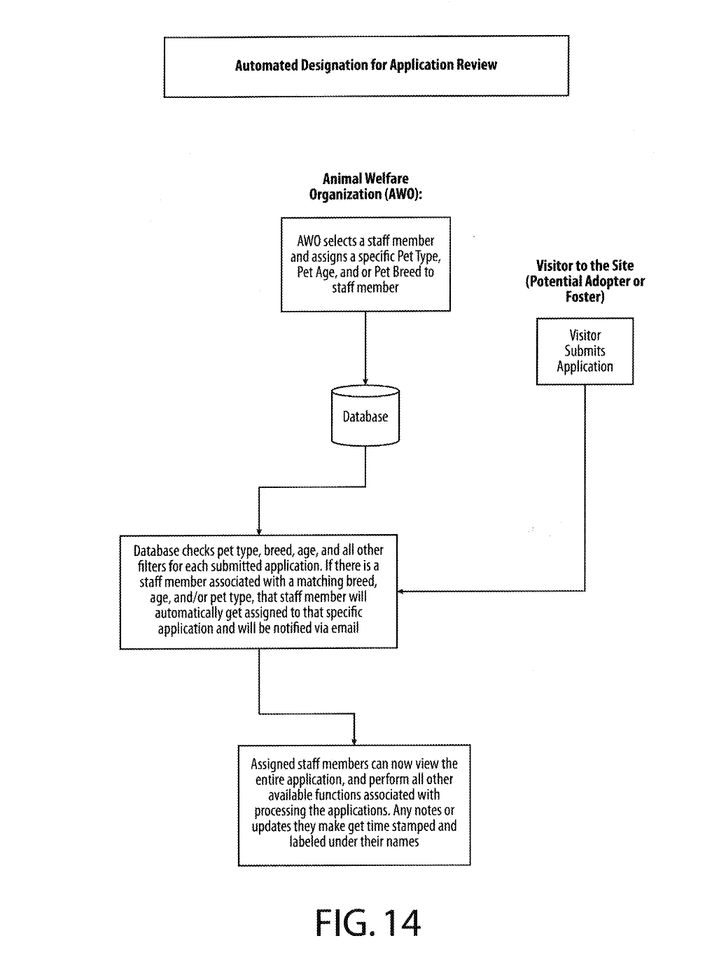

E. Automated Designation for Application Review: As illustrated in FIG. 14, automated designation for application review allows AWOs to assign staff members associated with their account to review each application. Many times an AWO will need to have multiple staff members review an application. Often, these staff members have to email all of their notes and documents they received to another staff member (who for example, may be in charge of performing the home visit). As a result, important information is often lost.

To resolve this problem, the AWOs can select which staff members can review and update the status of each application. Any time a staff member leaves a note about a particular application, the note is stored in the database, and the name of the staff member that created the note is associated with the note. Any time a staff member uploads a document, the document is saved and can be accessed any time by other staff members reviewing the same application. To save time, AWOs can set up their accounts so certain application types are automatically routed to a specific staff member (i.e. All baby dog applications go to staff member 1, all adult cat applications go to staff member 2, all other applications go to AWO administrator).

F. Automated Denied/Accepted List: The software creates and stores automated denied/accepted lists, which automatically highlight which applicants have already been denied or accepted in the past. Many times, applicants will apply again if they have been previously rejected (or accepted) due to poor answers in their initial application. Since they know the right answers the second time around, they try to trick organizations by submitting a better application. To help solve this problem, the system software will notify the AWOs any time an applicant submits an application with the same name as an applicant who is already placed in the denied list. From there the AWO can reject that application or contact the applicant for further review. The same can be done for applicants that have been previously accepted.
G. Instantly Input Paper Applications into our Application Software: The system allows AWOs to enter in or upload paper applications received offline into their account and put the application through the application screening. If an AWO uploads or enters an offline adoption application of someone not currently using the system, the applicant is sent an email with the option to join the site, track the application and track the animal's information after the application has been accepted and the animal is in their possession.
H. Auto-updating pet adoption widget: The system has the ability to allow AWOs to post all pets up for adoption/fostering to any site owned by the AWO in order to get more online exposure for the pets. The system provides each AWO with simple html/iframe code to automatically have their list of adoptable fosterable animals displayed any time a change is made to an individual pet in their account. Within the code/iframe provided by the system, each pet is linked directly to the pet's customized application (which the AWO created through the system). Anyone can apply to adopt/foster/volunteer using the system, and each applicant is given a free account: to keep track of the entire process through the system. Any time the status of the application is updated, the applicant will get an email notifi cation.
I. Automatic transfer of adoption documents: The AWOs are able to upload any documents they want transferred to the applicant's account: on the system website upon finalizing/accepting each application. Once the application is finalized and accepted, this information is automatically sent to the applicant's account. The applicant can then keep track of all of the pet's information and all adoption/foster documents associated with the pet (medical records, contracts). The applicant can also update their pet's records as needed. Additionally, the AWO can reach out to all accepted applicants through the system for reminders, check-ins, and updates.

No other system in this industry connects the AWOs to the Adopters, Fosters and Volunteers before and after the application is processed, to the extent possible with the present invention. Also, anyone that applies to adopt or foster a pet (or to volunteer at an AWO) will need to become a member of system. Since the system keeps track of everything including after the pet adopted/fostered, it can offer them products/services and allow them to update/track medical records and any other vital/important information related to their pets. No other AWO management software handles the entire end to end process in this manner. If the system were to include only 100 member AWOs processing 300 adoptions annually, the system would have 30,000 customers of the pet industry pumped into its revenue pipeline annually.

J. Automated application status updates: If two applications for the same pet are received, and one of those applications is accepted, the other application is stored in a “on hold” database. This allows the AWOs to find another pet for the qualified applicant. The AWO also has the ability to change the pet associated with each application before the application is accepted/finalized.
K. Transfer Assistance: The system helps provide transportation and offer/suggestion options that Adopters, Fosters and Volunteers can use to help transfer the pet from the AWO to the new location. The system does this by offering recommendations and services once the application is finalized/accepted. The system creates the recommendations by incorporating a rating system into the website and using those ratings, which allows the system to identify the top services and recommend them.
L. Background Checking: The system website will allow AWOs to automatically do a background check on anyone applying for a pet. This way the AWO can see if the applicant has prior instances of abuse. The system web site can sync with sites like dnapets.org, checkpet-abuse.com, pbaus.org, instantcheckmate.com, etc. and automatically return data to AWOs which request it. Further, an AWO can at its option pay for background check, an employer check, a vet check, references, etc.

Automated Medical Reminders and Expense Tracking: The system allows any AWO to set up automatic reminders for each pet in their account and track all medical expenses for each pet.

A. Automated Medical Reminders:

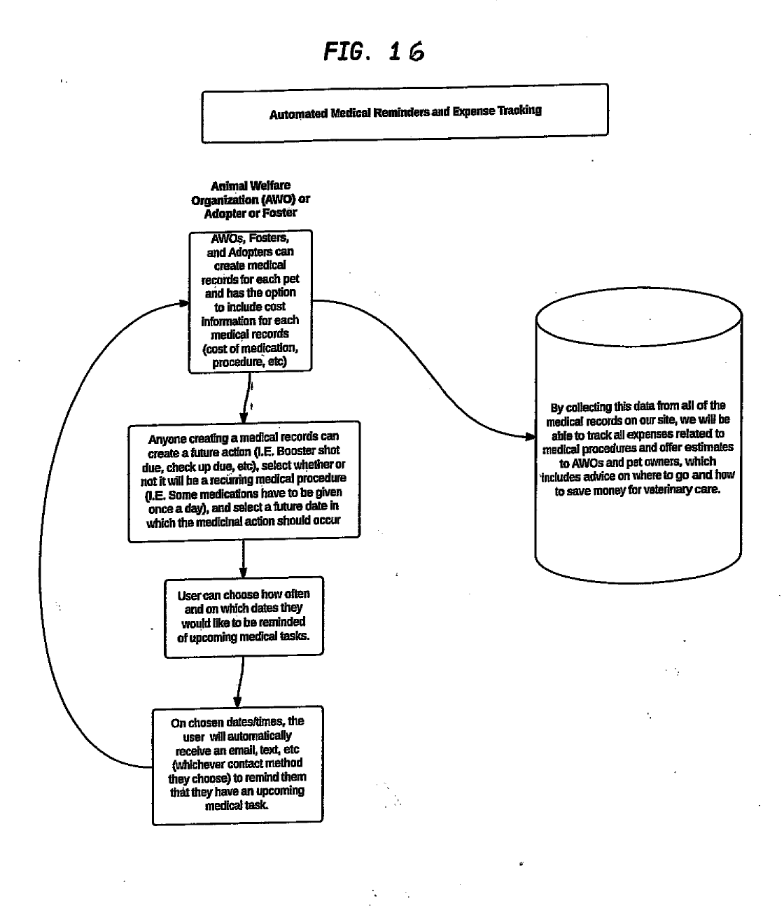

As illustrated in FIG. 16, if a pet needs a booster shot, is on a shot schedule, is due for a check-up, or has any other medical need planned in the future, the AWO is able to create a future action (i.e. booster shot due, check-up due, etc.), select whether or not it will be a recurring medical procedure (i.e. some medications have to be given once a day), and select a future date in which the medicinal action should occur. The AWO can then choose how often they would like to be reminded of upcoming medical tasks. The system can then send the AWO an email, text, etc. (whichever contact method the AWO chooses) to remind them that they have an upcoming medical task. The AWO can then record the task after it is completed. Also, once the pet is adopted, if the adoption is processed through the system. The system automatically send the pet's medical records (and any outstanding reminders) to the Adopter. The adopter and their veterinary will have this exact same functionality as the AWO.

B. Expense Tracking:

Any time a medical record is entered into the system, the AWO will be able to enter the cost into the system database. By collecting this data from all of the organizations on the system web site, the system will be able to track all expenses related to medical procedures and offer estimates to AWOs, which includes advice on where to go and how to save money for veterinary care.

Automatic Estimate Calculation of the Cost of a Dog/Cat at a Rescue: Currently, AWOs have no way of tracking how much it costs to have a dog/cat in their organization. By collecting information in the system database, the system can estimate the cost per day for each pet type in each AWO. The system can do this by allowing the AWO to enter in all costs associated with each pet in the system and calculating an average/estimate of cost per pet using an algorithm with all the variables (i.e. cost of food purchased, vet costs, total pets currently at AWO, cost of labor, etc.)

1. Instant Pet Service Registration:

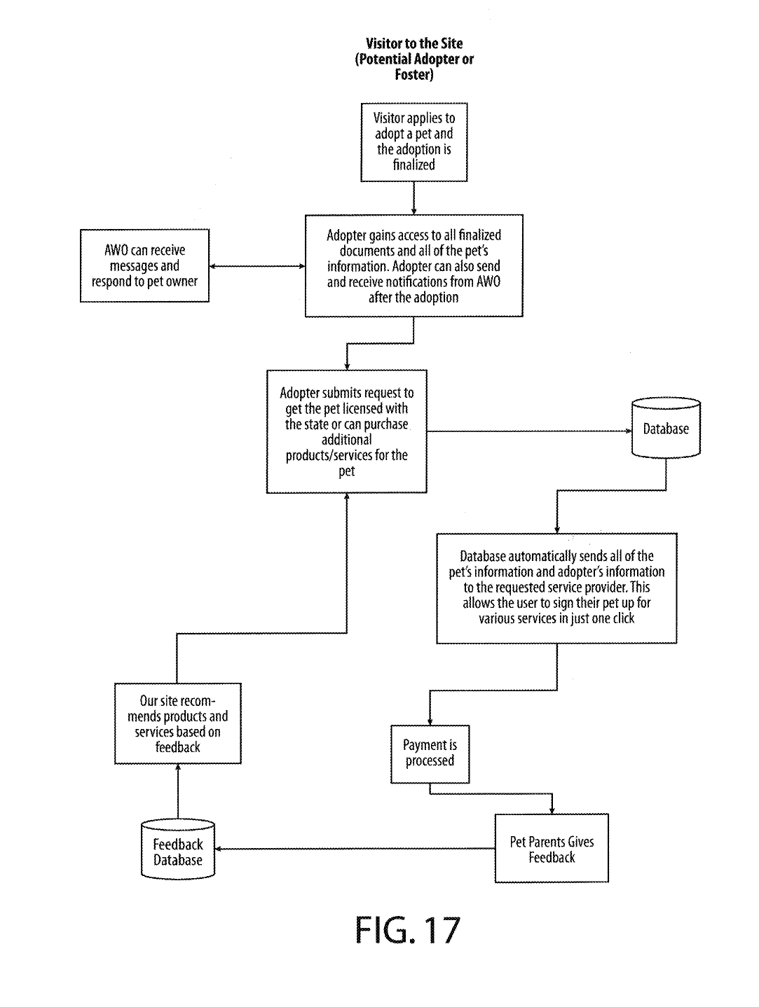

As illustrated in FIG. 17, after a pet adoption is processed through the system, the system sends all of the pet's information to the adopter's account on the system web site. From there, the adopter can instantly message the AWO and receive message from the AWO. They also now have access to a one click process where the pet owner can click a button and automatically register their pet with any other service. For example, for licensing, the system can instantly register the pet with the state they are located in (as long as they already have their information saved in the system databse, this will be instant) because the system database has already stored all of the pet's information and the owner's information. The system can sync with various other services and take a fee for each time one of the other services is used.

Smartphone/Tablet App That Scans Pet Microchips: Currently, when a pet is lost only certain scanners which can read 134 kHz and 125 kHz can look up the microchip numbers. By creating an app which will allow a smartphone or tablet to read a chip which is coded in specific frequencies, the system will eliminate the need for expensive in-house scanners and can allow anyone with a smartphone or tablet to scan a lost pet in order to figure out the pet's microchip number.

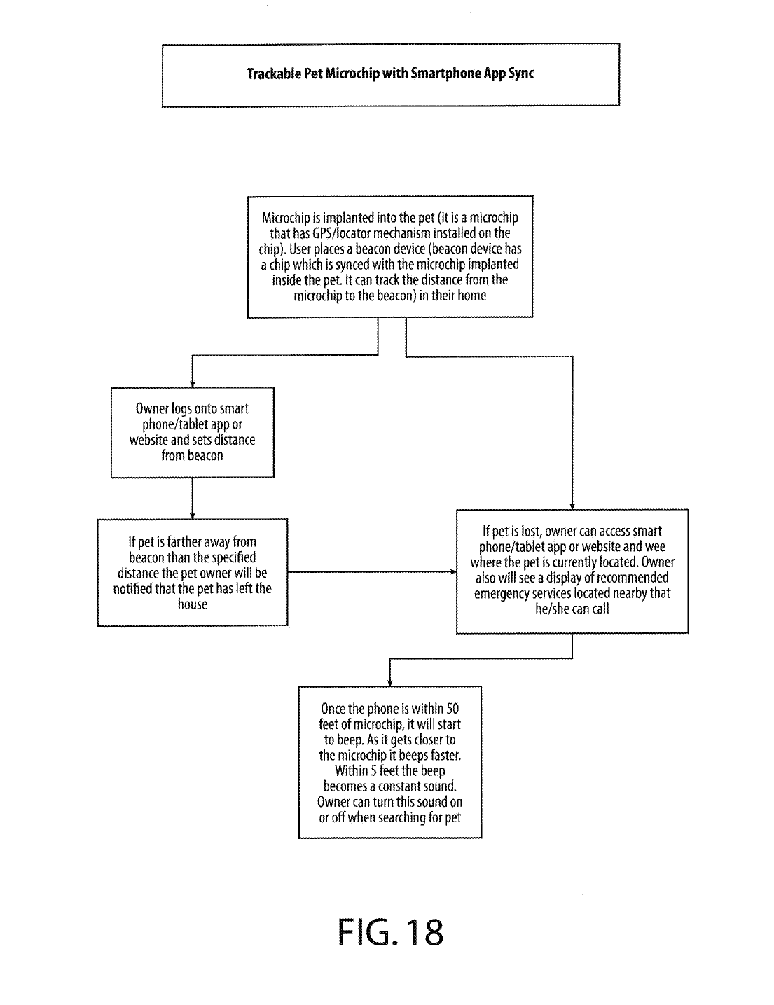

Trackable Pet Microchip: A special GPS microchip can be employed which can be implanted into any pet/non-human and, as illustrated in FIG. 18, can be synchronized with software developed to run as a smartphone/tablet application (“app”) or on the system website to send and receive messages. Because the chip contains a GPS locator, the chip and software can function as a proximity detector to alert the user if an animal with the implanted chip leaves a particular geographic area.

Using the GPS microchip and the software application, the system can do the following:
A. Instant Lost Notifications: The microchip, once implanted into the pet, will be able to automatically periodically notify the pet's owner exactly where their pet is currently located (within a specified radius) by periodically sending the software a signal including the approximate location (longitude and latitude) of the animal. If the animal ever gets lost or travels away from a set location, the software will automatically notify the owner (even if the owner is not at home).
   This can be accomplished by giving the animal owner a receptor with the chip, such that the owner can place inside the home and use it as a “home beacon”. Alternatively, the user can set a virtual beacon on a map and a maximum distance on the user's smartphone/tablet or through the system website. In this way, the software can function as a proximity detector such that when the animal with the embedded chip is located too far away from that receptor (i.e. the animal leaves the house and runs a mile down the road) or is outside the maximum set distance, the owner will be automatically notified.
B. GPS/Satellite/Location Tracking: The microchip, once implanted into the animal, will be able to display the exact location of the animal, and can automatically calculate the current distance from the owner. This feature will also include the ability for the software to create a signal having a frequency that is a function of the distance between the animal and the smartphone/tablet, for example a signal consisting of a series of beeps which increase in frequency as the smartphone/tablet gets within 50 feet, 25 feet, 10 feet, 5 feet, etc. of the animal.
C. Emergency Care: If an animal owner gets a lost notification or their animal is lost and its location is obtained using the chip and software, the software can cause the system website to provide emergency numbers in the proximity of the animal so the animal owner can call for help for the animal. The system does this by scanning local rescue sites using an algorithm and sending the telephone numbers of rescue services to the smartphone/Tablet of the animal owner. Subsequently, the animal owner may review and rate the services of the local rescue site and the system will store that information for future use by other animal owners by creating a relevancy score which is used to recommend the best rescue services.

While only a limited number of preferred embodiments of the present invention have been disclosed for purposes of illustration, it is obvious that many modifications and variations could be made thereto. It is intended to cover all of those modifications and variations which fall within the scope of the present invention, as defined by the following claims.

I claim:

1. An internet or wireless device-based, computer-implemented animal management system comprising a network of participating animal shelters offering pets for adoption, wherein potential adopting individuals may apply to the participating animal shelters by electronically submitting information on an application, said system comprising: means by which a participating animal shelter may customize such application by creating questions and answer choices for each question, and by selecting certain of said answer choices; and means for scanning a submitted application to review the answer choices to identify a selected answer choice.

2. The system of claim 1 further comprising means for automatically accepting or rejecting an application containing an identified selected possible answer.

3. The system of claim 1 wherein said means by which a participating animal shelter may customize such application by creating questions comprises means for specifying whether a question should appear in an application relating to a particular type of pet.

4. The system of claim 1 wherein said means by which a participating animal shelter may customize such application by creating questions comprises means for specifying the order of the questions on the application.

5. The system of claim 1 wherein said means by which a participating animal shelter may customize such application by creating questions comprises means for creating questions inquiring as to the age of the applicant or members of the applicant's family.

6. The system of claim 1 wherein the participating animal shelters provide pets for foster care and utilize volunteers to care for the pets at the shelters, and wherein individuals seeking to foster pets or to volunteer to care for pets at a participating animal shelter may apply to the participating animal shelter by electronically submitting information on an application through the system.

7. An internet or wireless device-based, computer-implemented animal management system comprising a network of participating animal shelters offering pets for adoptions, wherein potential adopting individuals may apply to the participating animal shelters by submitting information on an application, said system comprising: a database for storing each application and the answers submitted on the application; and means for assigning and storing an indication of the size of the participating animal shelter to which the submitted application is directed.

8. The system of claim 7 wherein the assigned size indication is a function of the number of adoptions and the number of returns of the participating animal shelter over a given time period.

9. The system of claim 8 further comprising means for providing a template which participating animal shelters of a particular size may use to increase adoptions and reduce return rates.

10. An internet or wireless device-based, computer-implemented animal management system comprising a network of participating animal shelters offering pets for wherein potential adopting individuals may apply to the participating animal shelters by electronically submitting information on an application, said system comprising: means for processing a submitted application through a multiple stage review process performed by at least one staff member of the participating animal shelter to which an application is submitted; means for selecting at least one staff member of the participating animal shelter to which an application is submitted to participate in the application review process; database means for storing documents and notes provided by the selected staff member for association with each stage of the review process for the submitted application; and means for the selected staff member to update the status of the submitted application as the submitted application moves through the review process.

11. The system of claim 10 further comprising means for storing requirements necessary for an application to pass through a stage in the review process.

12. The system of claim 10 further comprising means by which the selected staff member can store documents and notes received from others in the database.

13. The system of claim 10 further comprising means by which any staff member of the participating animal shelter to which an application is submitted other than a selected staff member may access the database to review the documents stored therein.

14. The system of claim 10 further comprising means for automatically assigning one or more pre-selected staff members of the participating animal shelter to which an application is submitted to participate in the application review process.

15. The system of claim 10 further comprising means for a participating animal shelter to upload paper applications created offline to be entered into the application review process.

16. The system of claim 10 further comprising means for a participating animal shelter to upload any documents to the system for automatic transfer to an applicant's account upon the acceptance of the application of such applicant.

17. The system of claim 10 wherein the participating animal shelters provide pets for foster care and utilize volunteers to care for the pets at the shelters, and wherein individuals seeking to foster pets or to volunteer to care for pets at a participating animal shelter may apply to the participating animal shelter by electronically submitting information on an application through the system.

18. The system of claim 17 further comprising means for electronically providing information to applicants to assist in transporting a pet from a participating animal shelter to a new location.

19. The system of claim 10 further comprising means for automatically electronically providing information to applicants as to the status of their applications.

20. The system of claim 10 further comprising means for allowing participating animals shelters to automatically preform a background check on an applicant.

21. The system of claim 10 further comprising means by which a participating animal shelter may electronically provide messages through the system to all individuals whose applications have been accepted by that participating animal shelter.

22. The system of claim 21 wherein said messages may include one or more of the following:
reminders, check-ins and updates.

23. The system of claim 17 further comprising means by which a participating animal shelter may electronically provide messages through the system to all individuals whose applications have been accepted by that participating animal shelter.

24. The system of claim 23 wherein said messages may include one or more of the following:
reminders, check-ins and updates.

25. An internet or wireless device-based, computer-implemented animal management system comprising a network of participating animal shelters offering pets for adoption, wherein potential adopting individuals may apply to a participating animal shelter by submitting information on an application, said system comprising means for tracking the number of times that an applicant has previously submitted an application.

26. The system of claim 25 further comprising means for tracking the number of times that an applicant has submitted an application which has been rejected.

27. The system of claim 25 wherein the participating animal shelters provide pets for foster care and utilize volunteers to care for the pets at the shelters, and wherein individuals seeking to foster pets or to volunteer to care for pets at a participating animal shelter may apply to the participating animal shelter by electronically submitting information on an application through the system.

28. An internet or wireless device-based, computer-implemented animal management system comprising a network of participating animal shelters offering pets for adoption comprising a database for storing medical information about each pet in a participating animal shelter, and means for automatically sending medical-related reminders to individuals who have adopted pets.

29. The system of claim 28 further comprising means for automatically sending medical—related messages about a pet to each adopting individual upon the successful completion of the adoption of that pet by the adopting individual.

30. The system of claim 29 wherein the medical-related reminders may include a schedule of a medical procedure.

31. The system of claim 30 wherein such medical-related reminders may include a single or a recurring medical procedure.

32. The system of claim 28 wherein said system further comprises a database, means for submitting records of medical procedures for each pet in the care of a participating animals shelter, including information as to the cost of each medical procedure, for storage in the database, and means for tracking the total cost in the database for the medical procedures performed on each such pet.

33. The system of claim 32 further comprising means for providing estimates for the medical care of a pet to participating animals shelters based upon the medical cost information in the database.

34. An internet or wireless device-based, computer-implemented animal management system comprising a network of participating animal shelters offering pets for adoption and maintaining those pets until adopted, the system comprising a database for storing information about the cost of maintaining a pet of a particular type in a participating animal shelter, and means for estimating the typical cost for a participating animal shelter to maintain a pet of that particular type over a particular time period, based upon the cost information the database.

35. An internet or wireless device-based, computer-implemented animal management system comprising a network of participating animal shelters offering pets for adoption comprising means for an adopting individual to receive information about a pet adopted by that individual through the system and means for the adopting individual and the participating animal shelter from which the pet has been adopted to communicate through the system.

36. An internet or wireless device-based, computer-implemented animal management system comprising a network of participating animal shelters offering pets for adoption comprising a database for storing information about a pet adopted by an individual through the system and means for connecting the system to an external pet registry through the internet and means for transferring information stored in the database to the external pet registry upon command of the individual to automatically register the pet with the external pet registry.

37. A method for using a GPS microchip associated with an animal and software for a smartphone, tablet or internet website capable of communicating with the GPS microchip, the method system comprising the steps of: selecting a location and a maximum distance from that selected location; storing the selected location and the set maximum distance; causing the GPS microchip to periodically obtain information as to the location of the associated animal and to transfer same to the software, causing the software to ascertain the distance between the selected location and the associated animal and to automatically generate a signal if the associated animal is situated at a distance from the selected location greater than the set maximum distance.
